(19) United States
(12) Patent Application Publication
(10) Pub. No.: US 2012/0068973 A1
(43) Pub. Date: Mar. 22, 2012

(54) Determining The Location Of An Object On A Touch Surface

(75) Inventors: Tomas Christiansson, Torna-Hallestad (SE); Ola Wassvik, Brosarp (SE)

(73) Assignee: FLATFROG LABORATORIES AB, Lund (SE)

(21) Appl. No.: 13/321,113

(22) PCT Filed: May 14, 2010
(86) PCT No.: PCT/SE2010/000135

§ 371 Date: Nov. 17, 2011

Related U.S. Application Data
(60) Provisional application No. 61/213,204, filed on May 18, 2009.

(30) Foreign Application Priority Data
May 18, 2009 (SE) 0950347-5

(51) Int. Cl. G06F 3/042

(52) U.S. Cl. 345/175

(57) ABSTRACT

An apparatus is operated to determine the location of at least one object on a touch surface (4) of a light transmissive panel (1). In the apparatus, an illumination arrangement (2, 10) generates a first set of sheets (C1-C3) of light and introduces the first set of sheets (C1-C3) via a first elongate incoupling site on the panel (1) such that the first set of sheets (C1-C3) propagate by internal reflection between the touch surface (4) and an opposite surface. At least two sheets in the first set of sheets (C1-C3) are introduced so as to overlap in a portion of the touch surface (4) such that the object interacts with the at least two sheets. Typically, each sheet (C1-C3) in the first set is essentially collimated in the plane of the panel (1) along a respective main direction. A detection arrangement (12, 14) couples the first set of sheets (C1-C3) out of the panel (1) at a first elongate outcoupling site on the panel (1) and generates output signals indicative of the energy of each sheet (C1-C3) at a set of spatial points within the first outcoupling site. A data processor is connected to identify, in the output signals, attenuation peaks caused by the touching object(s) and to determine the location of the object(s) based on the identified attenuation peaks.

### CROSS-REFERENCE TO RELATED APPLICATIONS

The present application claims the benefit of Swedish patent application No. 0950347-5, filed on May 18, 2009, and U.S. provisional application No. 61/213,204, filed on May 18, 2009, both of which are incorporated herein by reference.

### TECHNICAL FIELD

The present invention relates to techniques for detecting the location of an object on a touch surface. The touch surface may be part of a touch-sensitive panel.

### BACKGROUND ART

To an increasing extent, touch-sensitive panels are being used for providing input data to computers, electronic measurement and test equipment, gaming devices, etc. The panel may be provided with a graphical user interface (GUI) for a user to interact with using e.g. a pointer, stylus or one or more fingers. The GUI may be fixed or dynamic. A fixed GUI may e.g. be in the form of printed matter placed over, under or inside the panel. A dynamic GUI can be provided by a display screen integrated with, or placed underneath, the panel or by an image being projected onto the panel by a projector.

There are numerous known techniques for providing touch sensitivity to the panel, e.g. by using cameras to capture light scattered off the point(s) of touch on the panel, or by incorporating resistive wire grids, capacitive sensors, strain gauges, etc into the panel.

US2004/0252091 discloses an alternative technique which is based on frustrated total internal reflection (FTIR). Diverging beams from two or more spaced-apart light sources is coupled into a panel to propagate inside the panel by total internal reflection. The light from each light source is evenly distributed throughout the entire panel. Arrays of light sensors are located around the perimeter of the panel to detect the light from the light sources. Thus, a grid of light paths is set up in the panel between the light sources and the light sensors. When an object comes into contact with a surface of the panel, certain light paths will be attenuated. The location of the object is determined by triangulation based on the attenuated light paths. One drawback of this prior art system is that the density of light paths will vary across the panel. This may result in a varying touch sensitivity and performance across the panel.

U.S. Pat. No. 6,972,753 discloses another FTIR-based touch-sensitive system, in which two light sheets with high directivity are coupled into a rectangular panel from different sides of the panel to propagate by total internal reflection. Optical sensor arrays are arranged on the opposite sides of the panel to detect the quantity of received light. Thus, the light sheets are orthogonal, and a uniform grid of light paths may be set up in the panel. One drawback of this known system is that it requires access to all four sides of the panel in order to couple the two sheets of light into and out of the panel, which may put undesirable constraints on the design of the system. Furthermore, such a system is restricted to the use of two orthogonal light sheets.

### SUMMARY OF THE INVENTION

It is an object of the invention to at least partly overcome one or more of the above-identified limitations of the prior art.

This and other objects, which will appear from the description below, are at least partly achieved by means of apparatuses, methods and a computer program product according to the independent claims, embodiments thereof being defined by the dependent claims.

A first aspect of the invention is an apparatus for determining a location of at least one object on a touch surface, said apparatus comprising: a panel defining the touch surface and an opposite surface; an illumination arrangement configured to generate a first set of sheets of light and to introduce the first set of sheets via a first elongate incoupling site on the panel such that the first set of sheets propagate by internal reflection between the touch surface and the opposite surface, whereby at least two sheets in the first set of sheets overlap in a portion of the touch surface such that the object interacts with said at least two sheets; a detection arrangement configured to couple the first set of sheets out of the panel at a first elongate outcoupling site on the panel and generate output signals indicative of the energy of each sheet at a set of spatial points within the first outcoupling site; and a data processor connected to the detector arrangement for determining the location of the object based on the output signals.

In one embodiment, each sheet in the first set is essentially collimated in the plane of the panel along a different main direction. The main directions of the first set of sheets may define a maximum mutual acute angle of ≦30°, and preferably ≦20°. Alternatively or additionally, two of the main directions in the first set may be angled on either side of a direction parallel to a linear edge portion of the panel. In one implementation, another main direction in the first set of sheets is essentially parallel to said linear edge portion of the panel. Alternatively or additionally, each pair of main directions in the first set has a mutual acute angle that is unique within the first set.

In one embodiment, the illumination arrangement is configured to generate a second set of sheets of light and to introduce the second set of sheets via a second elongate injection site on the panel such that the second set of sheets propagate by internal reflection between the touch surface and the opposite surface, wherein each sheet in the second set is essentially collimated in the plane of the panel along a different main direction; and wherein the detection arrangement is configured to couple the second set of sheets out of the panel at a second elongate outcoupling site on the panel and generate output signals indicative of the energy of each sheet at a set of spatial points within the outcoupling site. The first incoupling site may be located at a first edge portion of the panel, and the first outcoupling site may be located at a second edge portion opposite to the first edge portion, and wherein second incoupling site may be located at a third edge portion of the panel, and the second outcoupling site may be located at a fourth edge portion opposite to the third edge portion, and the first and second incoupling sites may be parallel to the first and third edge portion, respectively. Alternatively or additionally, the first and second incoupling sites may be mutually orthogonal. Alternatively or additionally, the main directions of the second set of sheets may define a maximum mutual acute angle of ≦30°, and preferably ≦20°. Alternatively or additionally, the first set may comprise three sheets of light and/or the second set may comprise three sheets of light. Alternatively or additionally, each pair of main directions in the second set may have a mutual acute angle that is unique within the second set. Alternatively or additionally, each pair of main directions in the first and second set, respectively, may have a mutual acute angle that is unique within both the first set and the second set.

In one embodiment, the illumination arrangement comprises an first elongate collimating device that defines an input focal plane, wherein the collimating device is arranged to receive at least two input beams of light that diverge from a respective point of origin in said input focal plane, thereby causing the collimating device to output said first set of sheets.

In one embodiment the illumination arrangement comprises an elongate grating structure which is arranged to split an incoming beam of light into set of diffracted beams that form said first set of sheets. The incoming beam of light may be essentially collimated so as to have an essentially constant angle of incidence along the elongate grating structure, and the illumination arrangement may further comprise an elongate collimating device which is arranged to generate said incoming beam of light for the grating structure, wherein the collimating device may define an input focal plane and be arranged to receive an input beam of light that diverges from a point of origin in said focal plane. Alternatively or additionally, the illumination arrangement may comprise a plate-shaped radiation guide which is arranged underneath the panel, as seen from the touch surface, and a beam-folding system which is arranged to optically connect the radiation guide to the panel, wherein the radiation guide may be configured to guide said input beam(s) by internal reflection from one or more emitters to the beam-folding system.

In one embodiment, the detection arrangement comprises an array of radiation-sensing elements, which is arranged to optically face the outcoupling site such that different radiation-sensing elements receive light from different spatial points. The illumination arrangement may be operable to generate the first set of sheets simultaneously, and an angle filter may be arranged intermediate the outcoupling site and the array to limit the accepted angle of incidence at each radiation-sensing element, such that each radiation-sensing element only receives light from one of the sheets in the first set.

In one embodiment, the detection arrangement is arranged to measure the energy for each sheet at the spatial points in the first outcoupling site as a function of time. The detection arrangement may comprise an elongate focusing device configured to extend along the first outcoupling site to receive and focus each sheet in the first set onto a respective detection point, and at least one scanning detector which is arranged at the detection points to sweep its field of view along an output face of the elongate focusing device. The illumination arrangement may be operable to generate the first set of sheets simultaneously, and a separate scanning detector may be arranged at each detection point.

A second aspect of the invention is an apparatus for determining a location of at least one object on a touch surface, said touch surface being part of a panel that defines the touch surface and an opposite surface, said apparatus comprising: means for gene-rating a first set of sheets of light; means for introducing the first set of sheets via a first elongate incoupling site on the panel such that the first set of sheets propagate by internal reflection between the touch surface and the opposite surface, whereby at least two sheets in the first set of sheets overlap in a portion of the touch surface such that the object interacts with said at least two sheets; means for coupling the first set of sheets out of the panel at a first elongate outcoupling site on the panel; means for generating output signals indicative of the energy of each sheet at a set of spatial points within the first outcoupling site; and means for determining the location of the object based on the output signals.

A third aspect of the invention is a method of determining a location of at least one object on a touch surface, said touch surface being part of a panel that defines the touch surface and an opposite surface, said method comprising the steps of: generating a first set of sheets of light; introducing the first set of sheets via a first elongate incoupling site on the panel such that the first set of sheets propagate by internal reflection between the touch surface and the opposite surface, whereby at least two sheets in the first set of sheets overlap in a portion of the touch surface such that the object interacts with said at least two sheets; coupling the first set of sheets out of the panel at a first elongate outcoupling site on the panel; generating output signals indicative of the energy of each sheet at a set of spatial points within the first outcoupling site; and determining the location of the object based on the output signals.

A fourth aspect of the invention is a method of operating an apparatus for determining a location of at least one object on a touch surface, said touch surface being part of a panel that defines the touch surface and an opposite surface, said method comprising the steps of: operating an illumination arrangement to generate a first set of sheets of light and to introduce the first set of sheets via a first elongate incoupling site on the panel such that the first set of sheets propagate by internal reflection between the touch surface and the opposite surface to a first elongate outcoupling site, whereby at least two sheets in the first set of sheets overlap in a portion of the touch surface such that the object interacts with said at least two sheets; operating a detection arrangement to generate output signals indicative of the energy of each sheet at a set of spatial points within the first outcoupling site; and determining the location of the object based on the output signals.

A fifth aspect of the invention is a computer program product comprising computer code which, when executed on a data-processing system, is adapted to carry out the method of the fourth aspect.

Any one of the embodiments of the first aspect can be combined with the second to fifth aspects.

Still other objectives, features, aspects and advantages of the present invention will appear from the following detailed description, from the attached claims as well as from the drawings.

### BRIEF DESCRIPTION OF DRAWINGS

Embodiments of the invention will now be described in more detail with reference to the accompanying schematic drawings.

FIG. 1A is a side view of a simplified embodiment of a touch-sensing apparatus, and FIG. 1B is a top plan view of an implementation of the system in FIG. 1A.

FIGS. 2A-2B are a top plan view and a side view, respectively, of an exemplifying illumination arrangement for generating one or more sheets of light.

FIGS. 3A-3B are top plan views of an alternative illumination arrangements.

FIG. 4 is a top plan view of an exemplifying detection arrangement.

FIG. 5 is a top plan view of an alternative detection arrangement.

FIG. 6A is a top plan view of an exemplifying detection arrangement with an angular filter, FIG. 6B is a front view of a light-sensing array in the detection arrangement of FIG. 6A, and FIG. 6C is a top plan view of an exemplifying detection arrangement with an alternative angular filter.

FIG. 7 is a top plan view of a touch panel to illustrate main directions of light sheets that are propagated through the panel.

FIGS. 8A-8C are top plan views of another embodiment, with FIG. 8A illustrating main directions of light sheets, FIG. 8B illustrating the location of different sensing portions, and FIG. 8C illustrating an equiangular sheet arrangement.

FIGS. 9A-9B are top plan views of still another embodiment, with FIG. 9A illustrating main directions of light sheets, and FIG. 9B illustrating the location of different sensing portions.

FIG. 10A is a variant of the embodiment in FIG. 8 resulting in a dual v-sheets arrangement, FIG. 10B is a variant of the embodiment in FIG. 9 resulting in a dual Ψ-sheets arrangement, and FIG. 10C illustrates an asymmetric dual Ψ-sheets arrangement.

FIG. 11 illustrates the location of different sensing portions in an embodiment with a dual v-sheets arrangement with mutual angles of 6°, 12°, 20° and 40°.

FIG. 12 illustrates the location of different sensing portions in an embodiment with a dual Ψ-sheets arrangement with mutual angles of 6°, 12°, 20° and 40°.

FIG. 13 illustrates a set of touch points and resulting ghost points in an exemplifying arrangement of two sheets.

FIG. 14 illustrates a set of touch points and resulting ghost points in an exemplifying arrangement of three sheets.

FIG. 15 illustrates combinations of touch points that result in a degeneration of an equiangular arrangement of three sheets.

FIG. 16 illustrates modifications of the touch points in FIG. 15 that eliminate the degeneration.

FIG. 17A illustrates a combination of touch points that result in a degeneration of a v-sheets arrangement, and FIG. 17B illustrates a modification of the touch points in FIG. 17A that eliminates the degeneration.

FIG. 18A illustrates a combination of touch points that result in a degeneration of an asymmetric arrangement of three sheets, and FIG. 18B illustrates a modification of the touch points in FIG. 18A that eliminates the degeneration.

FIG. 19 illustrates the influence of removal of a touch point on degeneration in an asymmetric arrangement of three sheets.

FIG. 20 illustrates a combination of touch points that result in a degeneration of a dual v-sheets arrangement.

FIG. 21 illustrates the influence of removal of a touch point on degeneration in a dual v-sheets arrangement.

FIG. 22 illustrates a difference between a symmetric and an asymmetric Ψ-sheets arrangement in relation to four touch points.

FIG. 23 is a section view of an embodiment with a folded beam path.

FIGS. 24A-24B are section views of embodiments that include a transportation plate underneath the touch-sensitive panel.

FIG. 25 is a flow chart of an exemplary decoding process.

FIG. 26 is a block diagram of a data processor for determining touch locations.

### DETAILED DESCRIPTION OF EXAMPLE EMBODIMENTS

The following description starts by describing an embodiment of an overall touch-sensing system according to the present invention, followed by different embodiments of illumination arrangements and detection arrangements for such a system. Then, technical advantages of different light sheet combinations are explained, and exemplifying implementation details relevant to the overall system are discussed. Finally, an exemplifying algorithm for determining touch locations in the system is given. Throughout the description, the same reference numerals are used to identify corresponding elements.

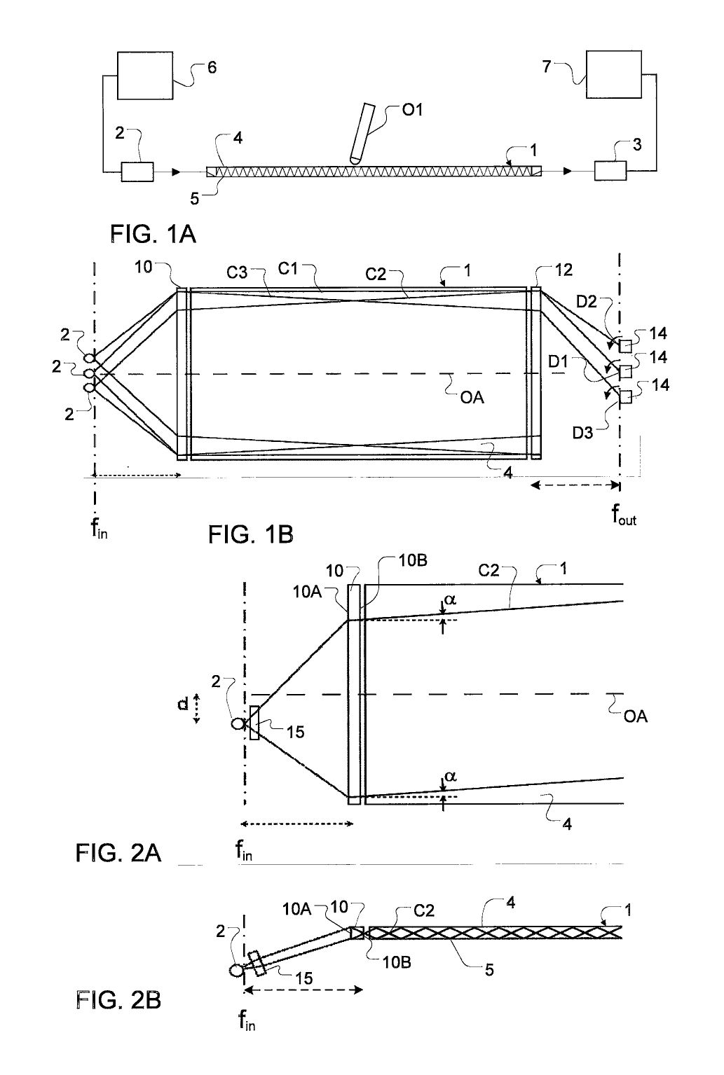

FIG. 1A is a side view of an exemplifying touch-sensing apparatus. The arrangement includes a light transmissive panel 1, one or more light emitters 2 (one shown) and one or more light sensors 3 (one shown). The panel defines two opposite and generally parallel surfaces 4, 5 and may be planar or curved. A radiation propagation channel is provided between two boundary surfaces of the panel, wherein at least one of the boundary surfaces allows the propagating light to interact with a touching object O1. Typically, the light from the emitter(s) 2 is injected to propagate by total internal reflection (TIR) in the radiation propagation channel, and the sensor(s) 3 is arranged at the periphery of the panel 1 to generate a respective measurement signal which is indicative of the energy of received light.

When the object O1 is brought sufficiently close to the panel 1, part of the light may be scattered by the object O1, part of the light may be absorbed by the object O1, and part of the light may continue to propagate unaffected. Thus, when the object O1 touches a boundary surface of the panel (e.g. the top surface 4), the total internal reflection is frustrated and the energy of the transmitted light is decreased.

The location of the touching object O1 may be determined by measuring the energy of the light transmitted through the panel 1 from a plurality of different directions. This may, e.g., be done by operating a number of spaced-apart emitters 2, by a controller 6, to generate a corresponding number of sheets of directional light inside the panel 1, and by operating one or more sensors 3 to detect the energy of the transmitted energy of each sheet of light. As long as the touching object attenuates at least two sheets of light, the position of the object can be determined, e.g. by triangulation. In the embodiment of FIG. 1A, a data processor 7 is configured to process the measurement signal(s) from the sensor(s) 3 to determine the location of the touching object O1 within a touch-sensing area. The touch-sensing area (“sensing area”) is defined as the surface area of the panel that is illuminated by at least two overlapping sheets of light.

As indicated in FIG. 1A, the light will not be blocked by the touching object O1. Thus, if two objects happen to be placed after each other along a light path from an emitter 2 to a sensor 3, part of the light will interact with both objects. Provided that the light energy is sufficient, a remainder of the light will reach the sensor 3 and generate a measurement signal that allows both interactions (touch points) to be identified. Thus, it may be possible for the data processor 7 to determine the locations of multiple touching objects, even if they are located in line with a light path.

FIG. 1B is a plan view of an exemplary implementation of the arrangement in FIG. 1A. In the implementation of FIG. 1B, three emitters are arranged to emit three diverging beams of light, also denoted “fan beams” in the following. The diverging beams may or may not be diverging also in the depth direction (i.e. transverse to the plane of the panel 1). All fan beams hit an elongate collimating device 10, which is designed to collimate each of the fan beams in one and the same geometric plane. The term “collimate in a geometric plane” as used herein is intended to indicate that all light rays are nearly parallel when viewed perpendicularly to the geometric plane. The collimating device 10 thus forms a set of collimated sheets C1-C3. In the context of the present disclosure, a “sheet of light” is synonymous with a “beam sheet” in which all light rays have been emitted concurrently. A sheet of light is also inherently spatially continuous in the plane of the sheet, and each position within the sheet can be assigned a single light ray direction. A “collimated sheet” is made up of light rays that, when projected onto the geometric plane, extend in a common main direction. A perfectly collimated sheet cannot be obtained due to diffractive effects, and in reality inaccuracies in optical components may also cause unintentional angular variations between the light rays within the sheet. Typically, such angular variations do not exceed ±2°.

As indicated in FIG. 1B, each sheet C1-C3 is collimated in a different main direction. The sheets C1-C3 are coupled into the panel at an elongate incoupling site, which in this example coincides with one side of the panel 1. The thus-injected sheets C1-C3 then propagate along the respective main direction through the panel 1, by internal reflection between the boundary surfaces 4, 5, until they reach an outcoupling site, at which each sheet C1-C3 is coupled out of the panel 1 and the energy of the sheet C1-C3 is measured by a detection arrangement. In the illustrated example, the outcoupling site coincides with the opposite side of the panel 1, and the outcoupled sheets hit an elongate focusing device 12, which is designed to focus the sheets C1-C3 onto separate detection points D1-D3. A scanner device 14 is arranged at each of the detection points to sweep its field of view along the focusing device 12 and to measure the received light energy as a function of sweep (time). Thus, each scanner device 14 measures the received light energy as a function of time for one of the sheets C1-C3. As will be further exemplified below, this means that the output signals of the detection arrangement represents the transmitted energy at a number of spatial positions along the outcoupling site, for each sheet C1-C3. This data allows the data processor 7 to determine the location of the object O1 of the touch surface 4.

One general characteristic of the touch-sensing apparatus in FIGS. 1A and 1B is that more than one sheet C1-C3 is injected into the panel 1 at a single elongate incoupling site, such that at least two sheets overlap in a portion (the sensing area) of the touch surface 4 and form a grid of intersecting light paths, as seen in a plan view of the touch surface 4. Thereby, the touching object O1 will interact with at least two sheets and the location of a touching object O1 can be determined based on the affected light paths. Since the sheets C1-C3 are introduced at a single incoupling site, touch determination is possible even with limited access to the panel 1. In the example of FIG. 1B, access is only needed at two opposite sides of the panel 1. This advantage is attained also for non-collimated sheets, i.e. sheets that diverge or converge in the plane of the panel, as long as the sheets overlap to define a grid of intersecting light paths.

Also, as seen in FIG. 1B, the sheets generally also overlap over a major extent of the incoupling and outcoupling sites. It should be understood that “elongate incoupling site” and “elongate outcoupling site” refer to linear portions of the panel 1, as seen in a plan view of the panel 1, where the sheets enter and leave the panel, respectively. Different sheets that enter the panel 1 through a “single incoupling site” may actually physically enter the panel on different paths within the incoupling site, e.g. through the top surface 4 (via a coupling element), through the bottom surface 5 (via a coupling element) and through the edge surface (see FIG. 1A). The same applies to sheets that leave the panel 1 through a “single outcoupling site”. However, for structural and functional simplicity, it may be advantageous for the incoupling/outcoupling site to introduce/withdraw two or more sheets through on one and the same path, e.g. through one of the top, bottom and edge surfaces.

Furthermore, if the sheets C1-C3 are essentially collimated, it is possible to attain a grid of intersecting light paths with well-defined mutual angles between the intersecting light paths. If desired, it is also possible to attain a uniform density of light paths within a large part of the panel.

As further explained below, it may be desirable to increase the number of main directions, and possibly also to increase the acute angles between the main directions of the sheets. This may be achieved by providing another pair of elongate incoupling and outcoupling sites, e.g. along other sides of the panel, whereby one or more further sheets can be propagated by internal reflections in the panel between these sites. Such a system may have an improved ability for multi-touch detection, i.e. an ability to determine the locations of more than one object that touches the touch surface during a sensing instance. A “sensing instance” is formed when the transmitted energy of all relevant sheets have been measured at all relevant spatial positions along the outcoupling site(s). Furthermore, increasing the number of sheets, and possibly the acute angles between the main directions, may not only be relevant for multi-touch detection, but may also improve the ability of the system to determine the shape and/or area of the touching object. Information on the shape and/or area of the touching object may be used for a number of different purposes by a post-processing system, e.g. to determine the pressure applied by the touching object on the touch surface, to discriminate between different types of objects (pens, fingers, palms, elbow, etc), to determine the orientation of a fingertip/hand etc on the touch surface, etc.

### Exemplifying Illumination Arrangements

As discussed above in relation to FIG. 1B, the illumination arrangement may include an emitter 2 which projects a fan beam onto an elongate input face of a fixed elongate collimating device 10 that is designed and arranged to collimate the beam into a desired main direction in a given geometric plane.

Generally, the collimating device 10 is an element or assembly of elements which is designed to re-direct incoming light rays depending on their angle of incidence. To limit the footprint of the touch-sensing system, the collimating device 10 may be placed near a periphery portion of the panel 1. For reasons of robustness and mounting precision, the collimating device may be mounted in contact with such a periphery portion.

In one embodiment, further illustrated in the top plan view of FIG. 2A and the side view of FIG. 2B, the collimating device 10 is an optical device that defines a focal plane fᵢₙ parallel to and at a distance from the elongate input face 10A of the optical device 10. Thus, all rays that originate from a point in the focal plane fᵢₙ and impinge on the input face 10A of the collimating device 10 will be output in the same direction, as seen in a geometric plane that extends along and away from an output face 10B of the collimating device 10 (e.g. the plane of the paper in FIG. 2A). Such a collimating device is simple to design, and provides a well-defined result.

It is to be understood that the device 10 may or may not be designed to also re-direct, e.g. collimate, the incoming rays in a geometric plane which is perpendicular to the above-mentioned geometric plane and to the output face 10B (e.g. in the plane of the paper in FIG. 2B). Further, to optimize the use of available light, it may be preferable that the extent of the fan beam in the depth direction is equal, or less, than the extent of the input face 10A in the depth direction, when the fan beam hits the collimating device 10. In the example of FIG. 2B, this is achieved by a cylindrical lens 15 which is arranged between the emitter 2 and the collimating device 10 to converge the fan beam onto the input face 10A.

As indicated above and shown in FIGS. 2A-2B, the fan beam is generated to expand from an origin located in the focal plane fᵢₙ of the collimating device 10. It is to be understood that the origin need not be a physical point defined by a small point source, but may instead be a geometrically reconstructed virtual point representing the rays that hit the input face of the device 10. By such an arrangement, the device 10 will convert the fan beam into a collimated sheet C2. As indicated, the angle α between the main direction of the sheet C2 and the optical axis of the optical device is given by the displacement d of the origin from the focal point of the optical device 10 (given by the intersection between the focal plane fᵢₙ and the optical axis OA of the optical device).

In the example of FIG. 2, the collimating device 10 is a lens device that transmits and redirects the incoming light. The lens device 10 may be made up of diffractive optical elements (DOE), micro-optical elements, refractive lenses and any combination thereof. In one presently preferred embodiment, the lens device is a Fresnel lens.

As already indicated in FIG. 1B, the lens device 10 in FIG. 2 can be used to generate a plurality of collimated sheets with different main directions. This can be accomplished by arranging the origins of a plurality of fan beams at different locations in the focal plane fᵢₙ of the lens device 10. In the example of FIG. 1B, three origins are arranged in the focal plane fᵢₙ. It is to be understood that the illumination arrangement exemplified in FIGS. 1B and 2 may be space-efficient, simple, robust and easy to assemble while providing collimated sheets with well-defined mutual angles between their main directions. Further, it allows the sheets to be generated concurrently, if desired.

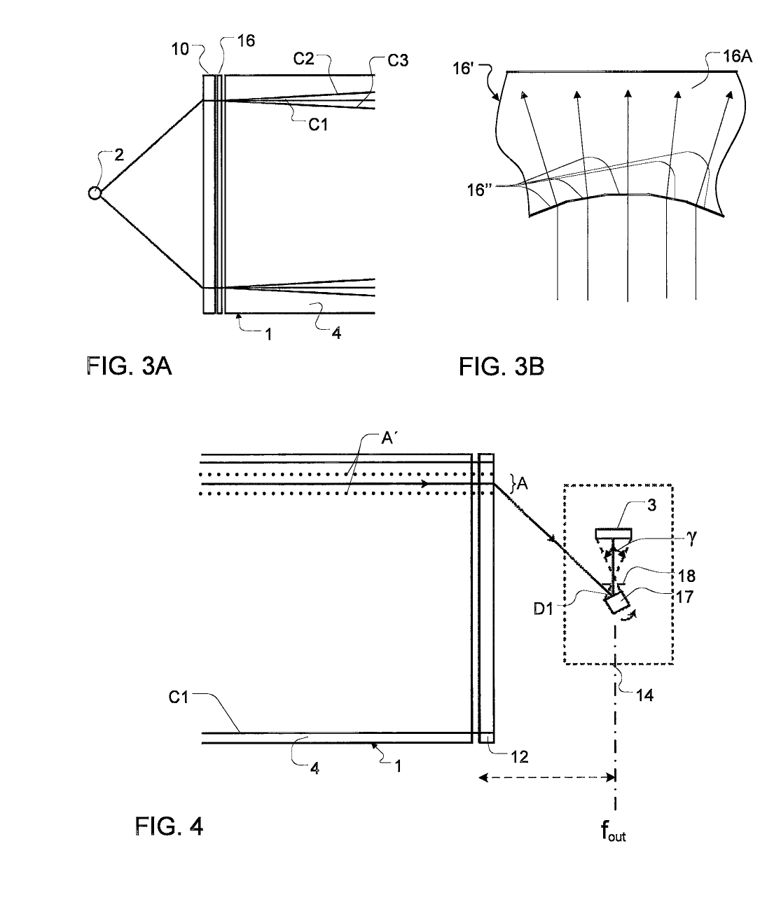

FIG. 3A illustrates an alternative or supplementary configuration of an illumination arrangement for generating a set of collimated sheets C1-C3 with well-defined mutual angles in a given geometric plane. In the embodiment of FIG. 3A, a single fan beam is emitted from a single origin in the focal plane fᵢₙ of the lens device 10, whereby the fan beam is converted to a collimated sheet with a well-defined main direction. The collimated sheet is received by a transmission grating 16, which diffracts the incoming sheet to generate a zero-order sheet C1 as well as first-order sheets C2, C3 on the sides of the zero-order sheet. Although not shown on the drawings, the grating 16 may be designed to generate sheets of higher orders as well. The mutual angles between the main directions of the different sheets C1-C3 are given by the properties of the grating 16 according to the well-known grating equation:

dₛ·(sin θₘ+sin θᵢ)=m·λ,

with dₛ being the spacing of diffracting elements in the grating, θᵢ being the angle of incidence of the light rays that impinge on the grating, m being the order, λ being the wavelength of the light, and θₘ being the angle between the main direction of the light rays of order m and the normal direction of the grating. This grating equation is generally applicable to all types of gratings.

The use of a grating 16 in combination with a lens device 10 provides an illumination arrangement with the potential of being space-efficient, simple, robust and easy to assemble while providing collimated sheets C1-C3 with well-defined mutual angles between their main directions. Further, it allows the sheets C1-C3 to be generated concurrently. It is to be understood that further main directions may be generated by providing more than one fan beam and arranging the origins of the fan beams in the focal plane fᵢₙ of the collimating device 10, e.g. as shown in FIG. 1B.

In the illustrated embodiments, the grating 16 is arranged downstream of the lens device 10. This will cause the grating 16 to be hit by an essentially collimated sheet, i.e. the main direction of the incoming sheet is essentially invariant along the extent of the grating 16, as seen in a top plan view (cf. FIG. 3A). Thereby, the set of sheets C1-C3 generated by the grating 16 are also essentially collimated in a given geometric plane. However, the grating 16 may alternatively be arranged upstream of the lens device 10, if the system is configured to accept larger variations in the main directions within the respective sheet C1-C3.

As an alternative to a transmission grating, a reflective grating may be used.

It is to be noted that, in all of the above-described illumination arrangements, the lens device 10 may be replaced by a fixed mirror device (not shown) that redirects the incoming radiation by reflection. The mirror device may be made up of diffractive optical elements (DOE), micro-optical elements, mirrors and any combination thereof. The above discussion with respect to the lens device is equally applicable to such a mirror device.

It is to be understood that the above-mentioned grating 16 may be integrated with the collimating device 10, be it a lens device or a mirror device.

As an alternative or supplement to a grating, the collimating device 10 may itself be configured to generate a set of output sheets with well-defined mutual angles, based on a single input beam. Such a collimating device 10 may comprise a set of elongate collimating segments (not shown) arranged on top of each other in the depth direction, where each collimating segment is arranged to generate an output sheet with a unique main direction, when hit by an input beam of at least the same width as the collimating device 10 in the depth direction. In one implementation, the focal points of the different collimating segments may be located at different positions in the input focal plane fᵢₙ. For example, the segments may all be designed from a basic collimating segment which is shifted in its longitudinal direction to form the different segments of the collimating device 10. Instead of being arranged on top of each other, the collimating segments may be superimposed on each other in the collimating device 10.

As yet another alternative or supplement to a grating, an elongate prism structure may be arranged intermediate the collimating device 10 and the panel edge (or a coupling element), wherein the prism structure comprises a repeating prism element in the longitudinal direction. FIG. 3B illustrates an example of such a prism element 16′, which has five differently inclined, planar prism surfaces 16″, whereby the input beam is directed in five different directions as it hits the prism structure. In the illustrated example the prism element 16′ is formed as an indentation in a surrounding material 16A. Alternatively, the prism element 16′ may be formed as a projection from the surrounding material 16A. The prism structure may be provided as a separate component, or it may be integrated in the panel edge or the coupling element.

In yet another alternative (not shown), each collimated and continuous sheet may be generated by an array of emitters that emit a respective beam of parallel light rays. The emitters are thus arranged such that their emitted beams have a common main direction and thus merge into a continuous sheet of light. It is to be understood that all emitters with the same main direction are activated concurrently to form such a continuous sheet. In such an alternative embodiment, the above-mentioned grating structure/collimating device/prism structure may be arranged intermediate the emitters and the incoupling site to generate a set of sheets from a single input sheet, as described above. Alternatively, the system comprises one array of emitters for each sheet. Instead of a physical array of emitters, an array of optical fibers could be used to form the collimated and continuous sheet(s), with the output ends of the optical fibers being configured to output parallel light rays.

In all illumination arrangements described herein, the emitter(s) 2 may be of any known type and configuration and may operate in any suitable wavelength range, e.g. in the infrared or visible wavelength region. All beams could be generated with identical wavelength. Alternatively, different beams could be generated with light in different wavelength ranges, permitting differentiation between the sheets based on wavelength. Furthermore, the emitter(s) 2 can output either continuous or pulsed radiation. For example, the emitter(s) 2 may include one or more of the following: a diode laser, a VCSEL (vertical-cavity surface-emitting laser), an LED (light-emitting diode), an incandescent lamp, a halogen lamp, etc. The emitter(s) 2 may further include beam-shaping optics, such as reflectors, lenses, etc to generate fan beam(s) with adequate properties. As noted above, the fan beam(s) may or may not be collimated in the depth direction of the panel. It is also to be noted that a single emitter 2 may be arranged to generate more than one fan beam, e.g. by the use of mirrors, lenses, optical fibers etc.

### Exemplifying Detection Arrangements

FIG. 4 is a plan view of the detection arrangement in FIG. 1B, albeit with all but one sheet C1 and one output scanner 14 being omitted. As discussed in relation to FIG. 1B, a fixed elongate focusing device 12 is arranged to receive and focus the incoming sheet C1 onto a detection point D1. In the example of FIG. 4, the output scanner 14 includes a movable deflection element 17 and a stationary light sensor 3. The deflection element 17 is arranged at the common detection point D1 to deflect incoming light rays in the sheet C1 onto the sensor 3. While the deflection element 17 is rotated (as indicated by arrow), light rays from different parts of the sheet C1 is directed onto the sensor 3. Non-limiting examples of suitable deflection elements 17 include a rotating mirror, a resonant mirror, a galvanometer mirror, a MEMS (Micro-Electro-Mechanical Systems) unit, a MOEMS (Micro Opto-Electrical-Mechanical Systems) unit, a liquid crystal, a vibrating mirror, an opto-acoustic unit, etc.

The output scanner 14 has a view angle (numerical aperture) γ which defines the set of light rays in the sheet C1 that are directed onto sensor 3 at each time point during the sweep. In other words, the view angle defines the spatial position/region A within the outcoupling site that is viewed by the sensor 3 (the dotted lines A′ indicate the boundaries of light rays in the panel that impinge within this spatial region A). In the example of FIG. 4, an aperture stop 18 is arranged between the sensor 3 and the deflecting element 17 to define the view angle. In other embodiments, the aperture stop 18 may be excluded, and the view angle may be defined by the sensor 3 or the deflecting element 17.

Generally, the focusing device 12 is an element or assembly of elements which defines an elongate input side for optically facing the sensing area. The term “optically facing” is intended to account for the fact that the focusing device 12 need not be arranged in the plane of the panel 1, but could e.g. be arranged above or beneath the plane to receive a sheet that has been coupled out of the panel 1, e.g. via one of the boundary surfaces 4, 5. To limit the footprint of the touch-sensing system, the focusing device 12 may be placed near a periphery portion of the panel 1. For reasons of robustness and mounting precision, the focusing device 12 may be mounted in contact with such a periphery portion.

In one embodiment, shown in FIG. 4, the focusing device 12 is an optical device that defines a focal plane fₒᵤₜ parallel to and at a distance from its input side. All rays that impinge on the input side at one and the same angle of incidence are directed to a common point in the focal plane fₒᵤₜ. Thus, it should be realized that the sheet C1, since it is essentially collimated in a given geometric plane, will be re-directed onto a well-defined detection point D1, at least in the geometric plane. It is to be understood that the sheet C1 may or may not be focused by the focusing device 12 in the depth direction of the panel 1.

The focusing device 12 makes it possible to separately detect the energy of more than one sheet downstream of the sensing area. In the example of FIG. 1B, collimated sheets C1-C3 with different main directions are focused onto different detection points D1-D3 by the device 12. Thus, if a respective output scanner 14 is arranged at each detection point D1-D3, as in FIG. 1B, each scanner 14 will only receive light from one of the sheets C1-C3, and the energy of the sheets C1-C3 can be measured separately, even if they are generated concurrently.

In an alternative arrangement (not shown), one output scanner 14 is arranged in the focal plane fₒᵤₜ to direct light from more than one detection point onto one and the same sensor 3. This means that the sensor 3 cannot discriminate between light that originates from different sheets, and therefore the sheets should be generated sequentially. Thus, the output scanner 14 is controlled to sweep its field of view along the focusing device 12 for each sheet separately.

The focusing device 12 may be a lens device that transmits and redirects the incoming light (as shown in FIG. 4), or a mirror device that redirects the incoming light by reflection. The focusing device 12 may be made up of diffractive optical elements (DOE), micro-optical elements, mirrors, refractive lenses, and any combination thereof. In one presently preferred embodiment, the focusing device 12 is a Fresnel component.

It is to be understood that the focusing device 12 can be arranged to focus or converge a sheet even if the sheet is not perfectly collimated, i.e. if the directions of the light rays in the sheet vary slightly across the sheet. Such variations may result from inaccuracies or tolerances in the illumination arrangement. The presence of such variations may cause the sheet to be focused into a slightly larger detection point. Suitably, the output scanner 14 is designed to direct all light that falls within this larger detection point onto sensor 3.

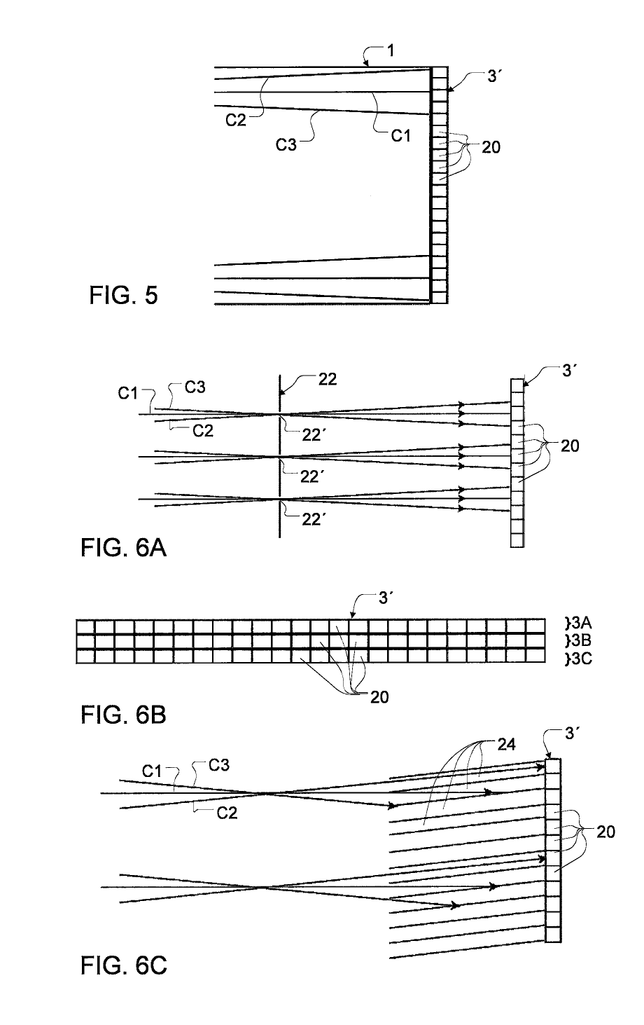

FIG. 5 illustrates another embodiment of a detection arrangement for detecting the light energy of different light sheets C1-C3 along an outcoupling site. The detection arrangement comprises an elongate array 3′ of light-sensitive elements 20 which are arranged to optically face the outcoupling site. Thereby, the different elements 20 are capable of measuring the received light energy at different spatial locations within the outcoupling site. The array 3′ may be implemented by a 1- or 2-dimensional light sensor which is arranged along the outcoupling site. Alternatively, the array 3′ may be implemented as a row of discrete O-dimensional light sensors. To limit the footprint of the touch-sensing system, the array 3′ may be placed near a periphery portion of the panel 1. For reasons of robustness and mounting precision, the array 3′ may be directly or indirectly attached to the panel 1, e.g. by means of optically clear glue. It is to be understood that the detection arrangement in FIG. 5 may be space-efficient, simple, robust and easy to assemble.

The detection arrangement in FIG. 5 does not discriminate between the different sheets C1-C3. Therefore, the illumination arrangement should be controlled to generate the sheets C1-C3 one by one, while a measurement signal is sampled from the light-sensing elements 20 for each sheet C1-C3 separately.

The detection arrangement in FIG. 5 may be modified to allow the sheets C1-C3 to be generated concurrently, by limiting the light-receiving angles of different light-sensing elements 20 in correspondence with the different main directions of the sheets C1-C3. Thus, the array 3′ may be subdivided into two or more elongate rows of elements, wherein each row is matched to detect light only at a specific angle of incidence (or a confined range of angles). This is typically achieved by arranging an angle filter between the outcoupling site and the array 3′.

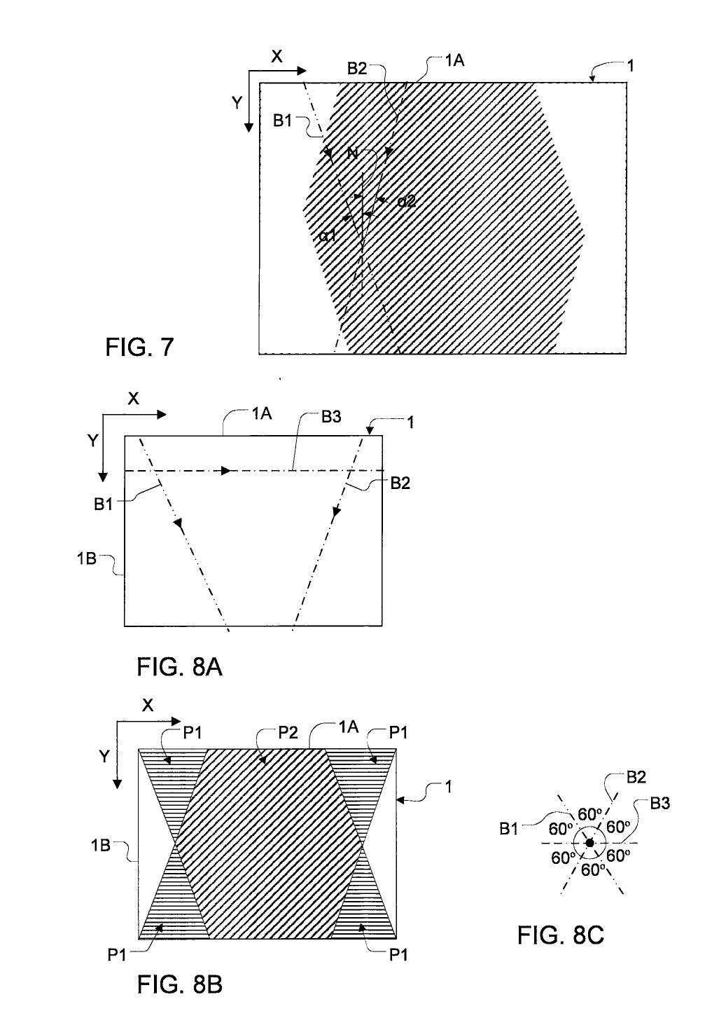

FIG. 6A is a plan view of a detection arrangement with an angle filter formed by a line of apertures 22′ in a non-transmissive plate 22 which is arranged in front of and parallel to the array 3′. The size and spacing of the apertures 22′, the distance between the plate 22 and the array 3′, and the size and spacing of the light-sensing elements 20 are matched such that each element 20 only receives light from one of the sheets C1-C3.

In the embodiment of FIG. 6A, the received energy is measured at slightly different spatial positions within the outcoupling site for each sheet C1-C3, since different sets of light-sensing elements 20 in the array 3′ are matched to different sheets C1-C3. FIG. 6B-6C illustrates an alternative embodiment which may be used to obviate this potential drawback. In this embodiment, the array 3′ comprises three rows 3A-3C of light-sensing elements 20, which are placed on top of each other, as shown in FIG. 6B which is a side view towards the light-receiving elements 20 of the array 3′. Each row 3A-3C only accepts light with a specific angle of incidence, which is matched to the main direction of one of the sheets C1-C3. FIG. 6C is a plan view showing the array 3′ and an angle filter for the top row 3A of light-sensing elements 20. As illustrated, the angle filter comprises one radiation channel 24 for each light-sensing element 20 in the top row 3A, wherein the inclination of the radiation channels is matched to the main direction of sheet C2. Similar angle filters with other inclinations are provided for the middle and bottom rows 3B, 3C.

In all of the above embodiments, the energy of the sheets C1-C3 may be measured by any type of sensor capable of converting radiation into an electrical signal. Such sensors include photo-detectors, CMOS and CCD sensors.

### Exemplifying Sheet Arrangements

In the following, touch-sensing systems using collimated sheets will be discussed in further detail. In particular, different sheet arrangements within the sensing area will be discussed with reference to FIGS. 7-12. Since these figures focus on the sheet arrangement with respect to the panel, most hardware components have been omitted. It is to be understood that the illustrated systems can be implemented by the same or a similar combination of components as described above with reference to FIGS. 1-6.

As will be further explained below, different sheet arrangements within the panel may provide different characteristics to the touch-sensing system, e.g. with respect to the precision in detecting touch locations, the number of touch locations that can be detected within a sensing instance, the technical complexity of the system, the footprint of the system, the relative size of the multi-touch sensing area to the total surface area of the panel, etc.

In the illustrated sheet arrangements, it is to be understood that the sheets need not physically intersect over the entire panel. For example, if the sheets are generated sequentially, light paths and points of intersection between the light paths can be reconstructed when each of the sheets has been generated.

Furthermore, it is to be understood that the following discussion about main directions refers to the main direction of each sheet, as seen in a plan view of the panel.

In the Figures, a Cartesian coordinate system has been introduced, with the coordinate axes X,Y being parallel to the sides of the rectangular panel. This is only for the purpose of illustration, and the touch locations can be represented in any type of coordinate system, e.g. polar, elliptic, parabolic, etc.

In one sheet arrangement, in which a set of sheets are injected via a common incoupling site at one edge portion of the panel, the main direction of at least one sheet is non-perpendicular to this edge portion. FIG. 7 illustrates an example of such a sheet arrangement in which two non-parallel sheets are generated, the main direction B1, B2 of each sheet defining a respective angle α1, α2 to the normal N of the edge portion 1A. This type of sheet arrangement with two non-parallel sheets that originate from a common injection site is denoted “v-sheets” in the following. In the illustrated v-sheets embodiment, the sensing area (indicated by hatched lines) is a subset of the surface area of the panel 1.

The ability of the touch-sensing system to detect the location of a plurality of objects touching the sensing area within a sensing instance is improved by generating more than two sheets within the sensing area. Example embodiments that enable this so-called “multi-touch” functionality will now be described with reference to FIGS. 8-12.

FIG. 8A-8B illustrates an embodiment in which three sheets are generated within the sensing area. In FIG. 8A, v-sheets are generated via a first incoupling site at a first edge portion 1A, and a single sheet is injected via a second incoupling site at a second edge portion 1B which is perpendicular to the first edge portion 1A. In the illustrated example, the main directions B1, B2 of the v-sheets have equal but opposite angles to the normal of first edge portion 1A. The sheet generated via the second incoupling site has a main direction B3 which is orthogonal to the second edge portion 1B. Thereby, as shown in FIG. 8B, the sensing area of the panel comprises a number of first sub-portions P1, in which each point of intersection is formed by light rays from two sheets, and a central second sub-portion P2, in which each point of intersection is formed by light rays from three sheets. In one specific embodiment, the main directions B1-B3 of the sheets are essentially equiangular within the second sub-portion P2. Such a sheet arrangement maximizes the mutual angle between the main directions B1-B3 of the sheets. A large mutual angle may improve the precision of the detected touch locations, at least in some implementations. By “equiangular sheets” is meant that, in each point of intersection, the main directions of the sheets are equally distributed over 360°. In this example, as shown in FIG. 8C, the sheets intersect with a mutual angle of 60° (α1=α2=30°.

Although it may be desirable for the sheets to be equiangular within the sensing area, such a sheet arrangement may restrict the sensing area to the central portion of the panel (cf. sub-portion P2), whereas the remainder of the total panel surface is wasted. Thus, the footprint of the touch-sensing system may become excessive in relation to the size of the sensing area.

However, as indicated above, there are sub-portions (cf. sub-portion P1) outside the central portion that are traversed by two sheets, albeit not in an equiangular configuration. These sub-portions may also offer touch-sensitivity. However, the performance may differ between the central portion and these sub-portions, e.g. with respect to the precision that can be attained in the determination of the location of each object, as well as the number of simultaneous touches that can be discriminated. The overall performance of the system may be improved by increasing the number of sheets that are propagated across the panel, but increasing the number of sheets will also increase the number of sub-portions that are traversed by a different number of sheets. Thus, differences in performance may prevail across the panel. Furthermore, it may be desirable to avoid propagating more than about 6-10 sheets across the panel. As the number of sheets increases, so does the cost, the technical complexity and possibly the footprint of the system. Furthermore, since the sampling rate of the processing system is normally constant at a certain price point, increasing the number of sheets will decrease the number of samples per sheet. It is also possible that the measured signal level for each sample decreases with an increased number of sheets.

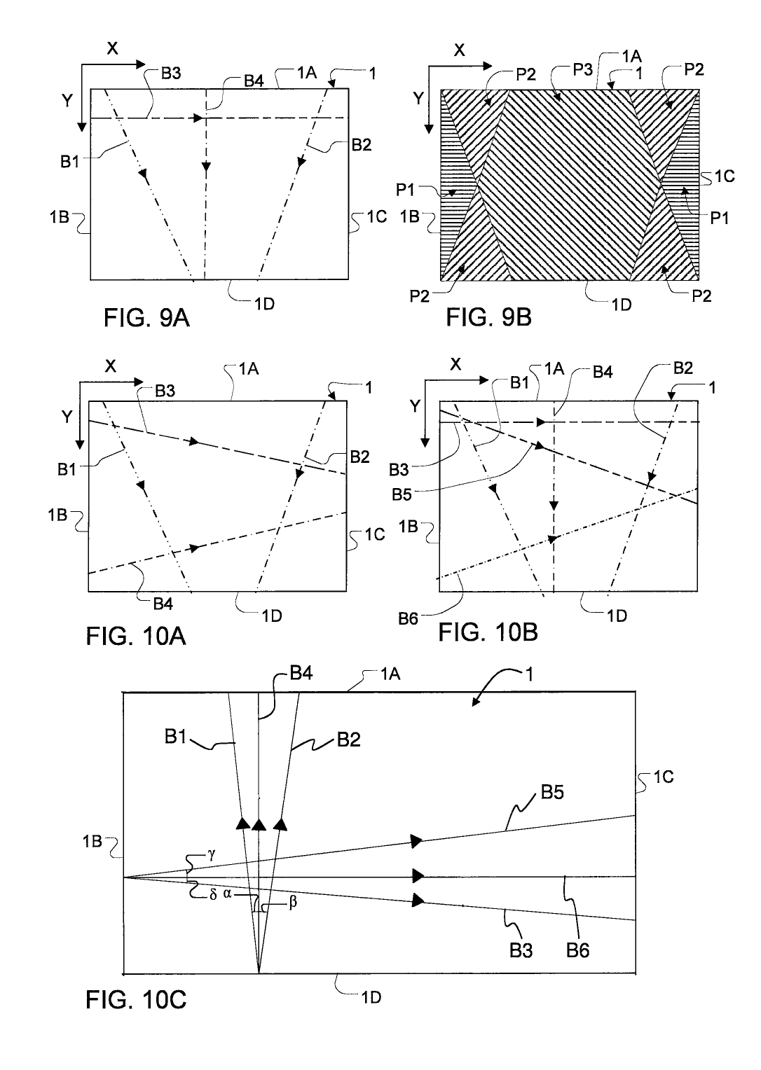

FIG. 9A illustrates a variant of the embodiment in FIG. 8A, in which one further sheet is additionally injected via the first incoupling site. In the illustrated example, this sheet is orthogonal to the first edge portion 1A, and thus parallel to the second edge portion 1B and the edge portion 1C opposite to the second edge portion 1B, whereby the sensing area is extended to the entire panel 1. As shown in FIG. 9B, the sensing area comprises two first sub-portions P1, in which each point is traversed by two sheets, and four adjacent second sub-portions P2, in which each intersection point is traversed by three sheets, as well as a central third sub-portion P3, in which each intersection point is traversed by four sheets. In this embodiment, the equiangular sheets are supplemented by an additional sheet in order to expand the extent of the sensing area. This expansion is achieved by generating a combination of v-sheets (B1 and B2) and an orthogonal sheet (B4) via the first incoupling site. This combination of sheets is denoted “Ψ-sheets” in the following. It should also be noted, by comparing FIG. 9B and FIG. 8B, that the overall performance of the panel has been increased since all sub-portions are traversed by a greater number of sheets. However, there may still be differences in performance across the panel.

FIG. 10A illustrates a variant of the embodiment in FIG. 7, wherein each of first and second incoupling sites is used to generate two mutually non-parallel sheets, i.e. v-sheets, and FIG. 10B illustrates a variant of the embodiment in FIG. 9, wherein each of the first and second incoupling sites is used to generate two mutually non-parallel sheets and an orthogonal sheet, i.e. Ψ-sheets.

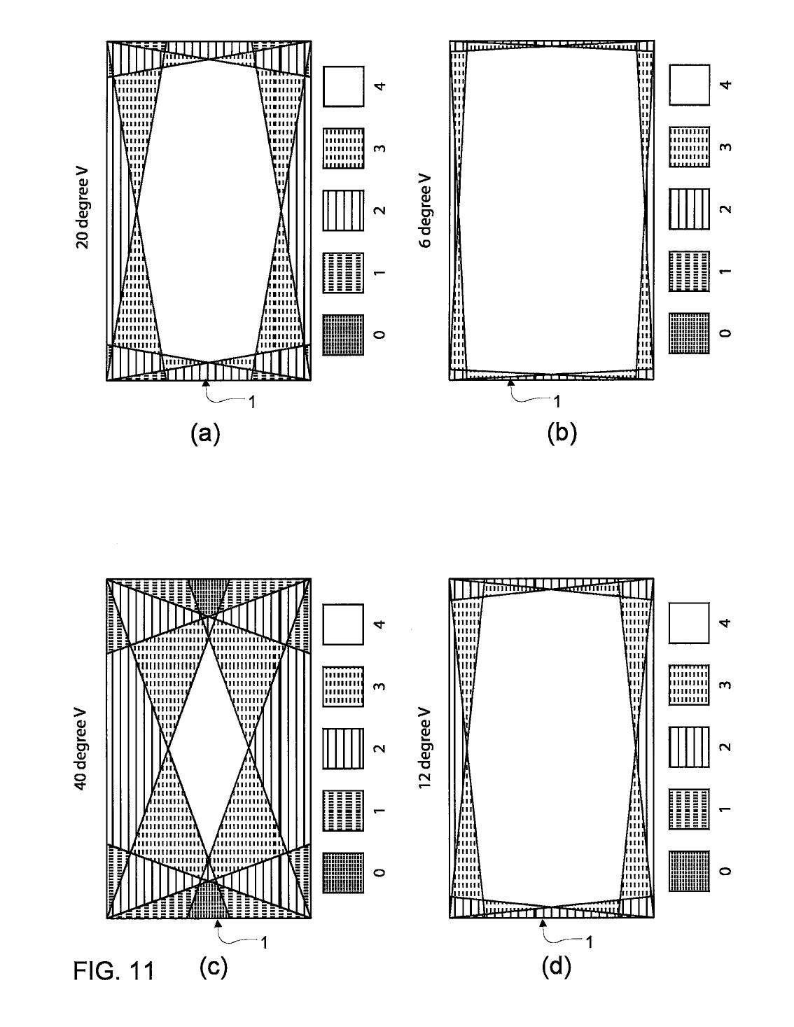

FIG. 11 illustrates the location of different sub-portions on a rectangular panel traversed by four sheets in the dual v-sheets configuration shown in FIG. 10A. Specifically, FIG. 11 shows how the extent and location of these sub-portions changes when a different mutual acute angle is set up between the main directions in each of the v-sheets (i.e. the angle between main directions B1 and B2, and between main directions B3 and B4, respectively in FIG. 10A). At a mutual acute angle of about 20° (FIG. 11(a)), a major part of the panel is traversed by four sheets. Thus, the performance of the system is the same over a large part of the panel. Reducing the mutual acute angle further, increases the extent of the central sub-portion and decreases the size of the other sub-portions. At an angle of about 12°-15° (FIG. 11(d)), there are essentially no sub-portions that are traversed by less than two sheets, and thus the entire panel is touch-sensitive. At an angle of about 2°-8° (FIG. 11(b)), the entire panel can be considered to present an essentially uniform performance. Although the performance of the system is reduced as the mutual angle is decreased, it has been found that adequate performance can be achieved at mutual acute angles from about 2° up to about 30°.

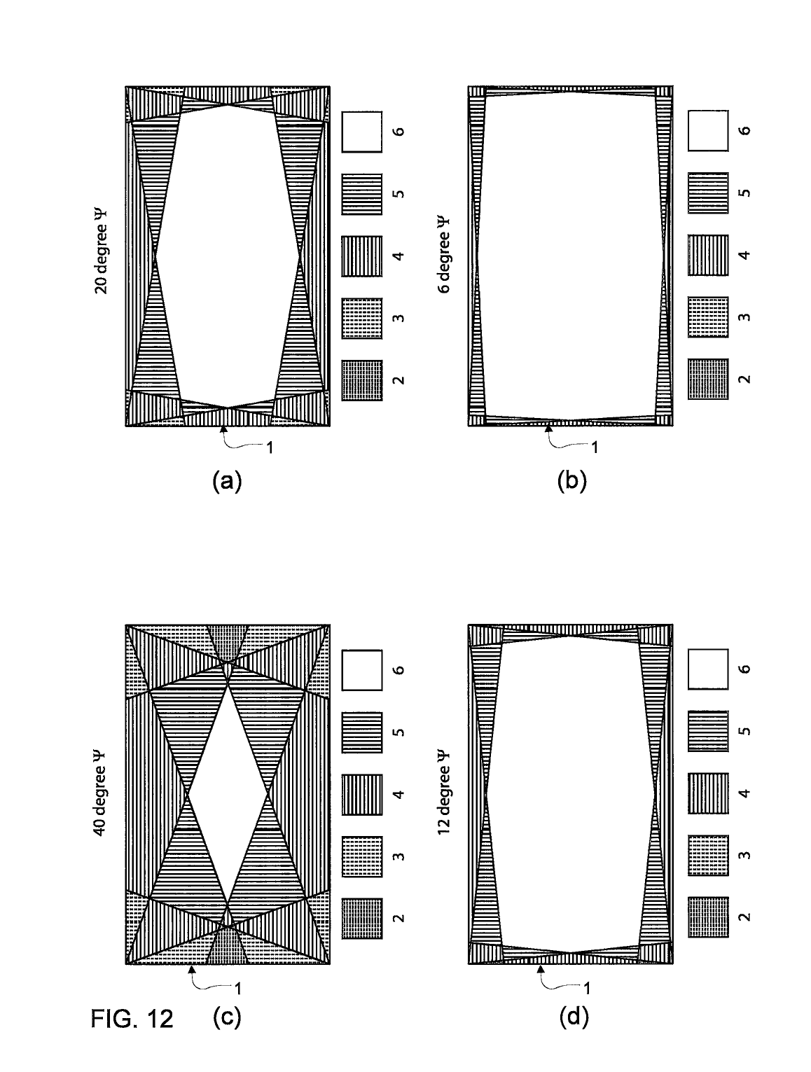

FIG. 12 illustrates the location of different sub-portions on a rectangular panel traversed by six beams in the dual Ψ-sheets configuration shown in FIG. 10B. FIG. 12 shows the influence of the maximum mutual angle between the main directions in each of the Ψ-sheets (i.e. the angle between main directions B1 and B2, and between main directions B5 and B6, respectively in FIG. 10B). The distribution and size of the sub-portions do not differ between FIG. 12 and FIG. 11. However, with dual Ψ-sheets, each sub-portion is traversed by two more sheets, which serves to increase the performance of the system. For example, the ability of the system to detect multiple touches is enhanced, and already at a maximum mutual angle of about 12°-15° (FIG. 12(d)), there are essentially no sub-portions that are traversed by less than four sheets.

Generally, a v/Ψ-sheets configuration involves generating at least one set of sheets with mutually acute main directions via one incoupling site on the panel, wherein the main directions of the sheets included in the set have a maximum mutual acute angle of ≦30°, and preferably ≦20°. In a v-sheets configuration, there are two sheets in each set, and in a Ψ-sheets configuration there are three sheets in each set. In a Ψ-sheets configuration, the main direction of one of these sheets is preferably orthogonal to the edge portion at the incoupling site.

One benefit of setting the central main direction in a Ψ-sheets configuration to be orthogonal to the edge portion of the incoupling site, is that the central sheet can traverse the whole panel, at least if the panel is rectangular. Compared to a dual v-sheets configuration, the two central sheets of a dual Ψ-sheets configuration may traverse the entire panel, and this may result in a significant improvement in performance at the periphery of the panel.

A general advantage of using v- and Ψ-sheets is that suitable performance of the touch-sensing system can be attained by propagating only a few sheets across the panel. Furthermore, both v- and Ψ-sheets can be realized by space-efficient, simple and robust combinations of components, for example by the illumination and/or detection arrangements as described herein.

It has surprisingly been found that an asymmetric sheet arrangement may enable determination of a greater number of touch locations for a given number of sheets, and/or improve the robustness in determining touch locations. Such an asymmetric sheet arrangement may be obtained by arranging at least three sheets such that the main directions of each pair of sheets define a unique mutual acute angle. For example, each pair of main directions in a set of sheets in a Ψ-sheets configuration may have a unique mutual acute angle. In another variant, an asymmetric sheet arrangement is obtained by arranging at least two sheets such that they have different angles to the edge portion at their common incoupling site (e.g. α1≠α2 in FIG. 7).

FIG. 10C illustrates a dual Ψ-sheets arrangement that may be asymmetric by proper choice of mutual acute angles between the main directions B1-B6. In the terminology of FIG. 10C, the mutual acute angles are given by α, β and (α+β) in one set of sheets (main directions B1, B2 and B4), and by γ, δ and (γ+δ) in the other set of sheets (main directions B3, B5 and B6). Thus, a suitable asymmetric sheet arrangement is obtained when α≠β and/or γ≠δ. The asymmetric properties may be improved further by selecting α≠β≠γ≠δ, and even further by selecting α≠β≠γ≠δ≠(α+β)≠(γ+δ). An even more asymmetric sheet arrangement is obtained when α, β, γ and δ are selected such that all mutual acute angles defined between the main directions B1-B6 are unique. In one such non-limiting example, α=6°, β=8°, γ=7° and δ=5°. If the panel is rectangular, with mutually opposite long sides and short sides, the asymmetric properties may be chosen such that the set of sheets (main directions B3, B5 and B6) generated via an incoupling site on a long side 1A of the panel has a smaller maximum mutual acute angle than the other set of sheets (main directions B1, B2 and B4), i.e. (γ+δ)<(α+β). Such a sheet arrangement may increase the sensing area of the panel compared to other asymmetric dual Ψ-sheets arrangements.

It should also be noted that any one of the sheet arrangements described in the foregoing may be combined with further sheets that do not comply with any one of the above design principles. For example, a set of equiangular sheets may be combined with one or more further sheets that are non-equiangular with the set of equiangular sheets. It is also possible to combine any one of the sheet arrangements described in the foregoing, e.g. a v-sheets configuration with a Ψ-sheets configuration, equiangular sheets with one or more v-sheets or Ψ-sheets configurations, etc.

### Degeneration of Sheet Arrangements

In the following, features of different sheet arrangements will be further explained with reference to a number of examples. These examples make use of the following definitions.

Sᵢ: A measurement signal along the outcoupling site for sheet i.

Sᵢⱼ: A light path for sheet i, where j is an index of the peak in the measurement signal originating from one or more touch points along the light path. Each light path has a total transmission Tᵢⱼ.

pₙ: A touch point, where n is an index of the touch point. The touch point is generated by an object touching the panel.

gₘ: A ghost point, where m is an index of the ghost point. A ghost point is defined as a non-existing touch point, which cannot immediately be discarded as being non-existing based on the measurement signals.

In an FTIR system, each touch point pₙ has a transmission tₙ, which is in the range 0-1, but normally in the range 0.7-0.99. The total transmission Tᵢⱼ along a light path may be given by the product of the individual transmissions tₙ of the touch points pₙ on that light path: Tᵢⱼ=Πtₙ. For example, two touch points p₁ and p₂ with transmissions 0.9 and 0.8, respectively, on a light path Sᵢⱼ, may yield a total transmission Tᵢⱼ=0.72.

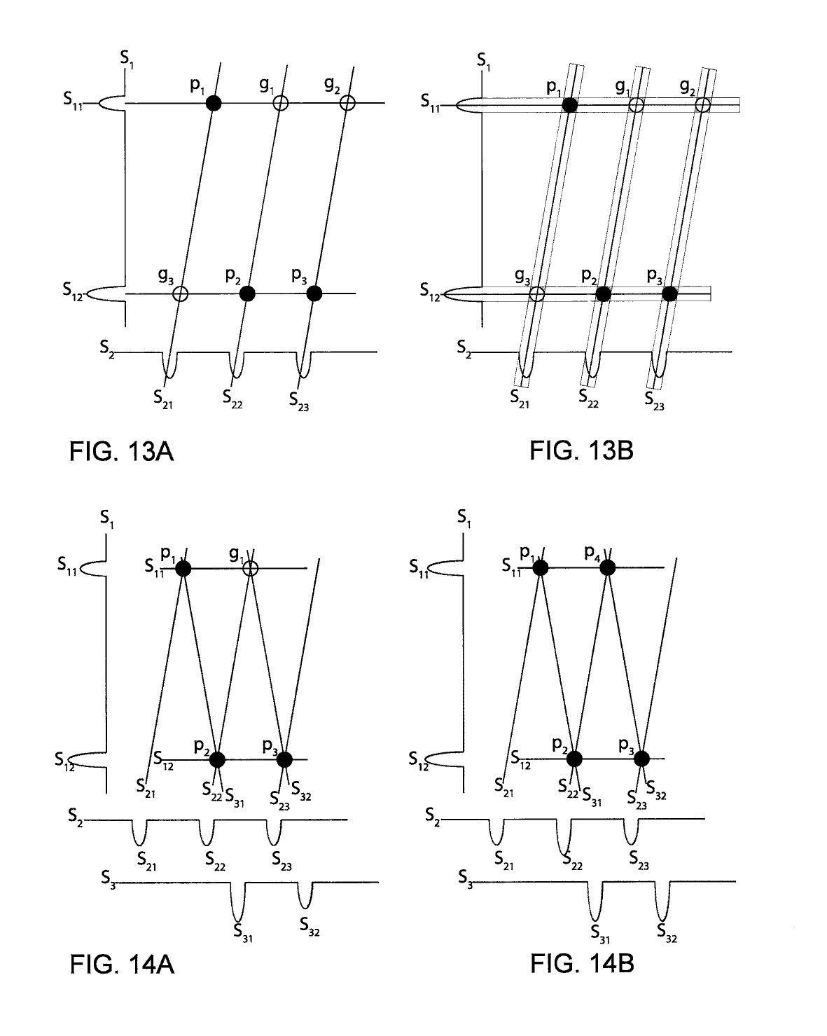

This is further illustrated in FIG. 13A, which shows light paths and measurement signals resulting from two sheets. It should be understood that the processing of the measurement signals aim at identifying the touch points among a set of candidate touch points given by the measurement signals. In this example, the candidate points consist of three touch points p₁-p₃, and three ghost points g₁-g₃. The candidate touch points are defined as positions where all available light paths come together, i.e. one light path from each sheet intersect at a single position. If the touch point has an extended area, the light paths gain width and the candidate touch points become the union of intersecting light paths from each sheet. This is illustrated in FIG. 13B, in which the grey areas surrounding the touch points and ghost points indicate the union of intersecting light paths.

In FIG. 13, a total of five light paths S₁₁, S₁₂, S₂₁, S₂₂, S₂₃ can be identified from the measurement signals S₁, S₂. The light paths yield the following transmissions: T₁₁=t₁, T₁₂=t₂·t₃, T₂₁=t₁, T₂₂=t₂, and T₂₃=t₃.

FIG. 14 shows light paths and measurement signals resulting from three sheets with a sheet arrangement as in FIG. 8. FIG. 14A illustrates a case with three touch points p₁-p₃, and FIG. 14B illustrates a case with four touch points p₁-p₄. The measurement signals S₁-S₃ differ between these cases, since the transmission from p₄ is multiplied with the transmissions from the other points along the light paths, as applicable. This also means that once the transmission tₙ for one touch point pₙ is determined, this transmission tₙ can be eliminated from the total transmission of other light paths that intersect this touch point pₙ. In the example, of FIG. 14B, the transmission of touch points p₁ and p₃ can be determined, since light path S₂₁ hits only touch point p₁ and light path S₂₃ hits only touch point p₃. By measuring T₂₁ and T₂₃, the values of t₁ and t₃ are known: t₁=T₂₁ and t₃=T₂₃. Then, the transmissions t₂ and t₄ of the other touch points p₂ and p₄ can be determined:

$${t}_{4} = \frac{{T}_{32}}{{t}_{3}} , and {t}_{2} = \frac{{T}_{12}}{{t}_{3}} .$$

Since all transmissions t₁-t₄ have been determined, it can be assessed whether the touch point p₄ exists or not.

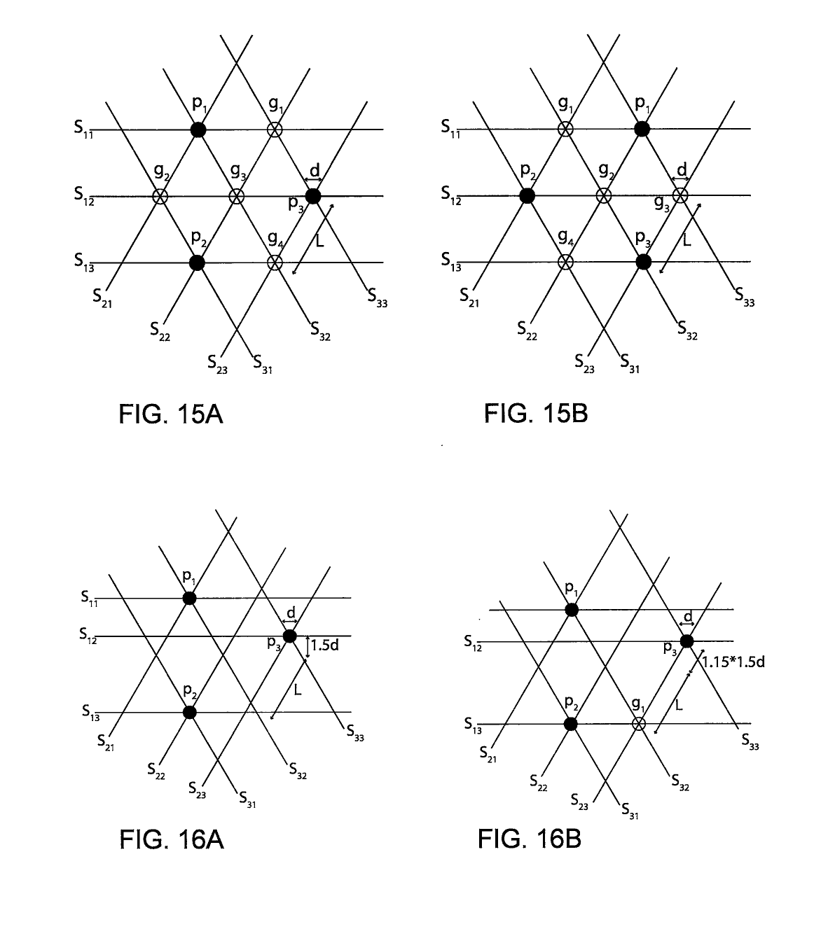

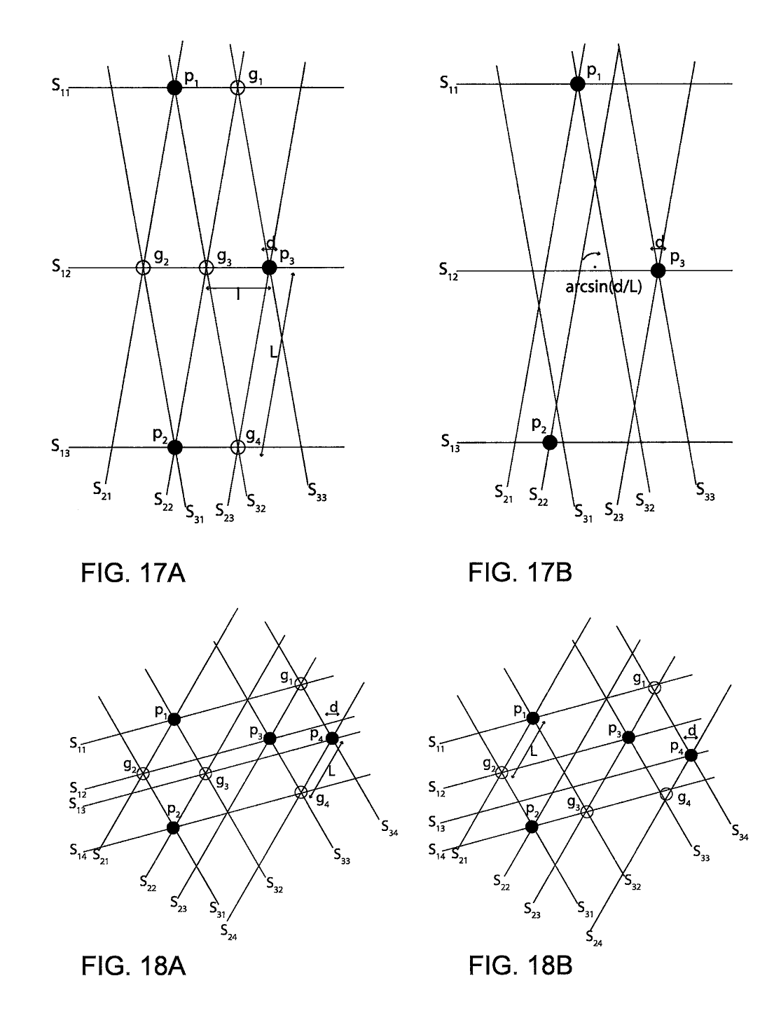

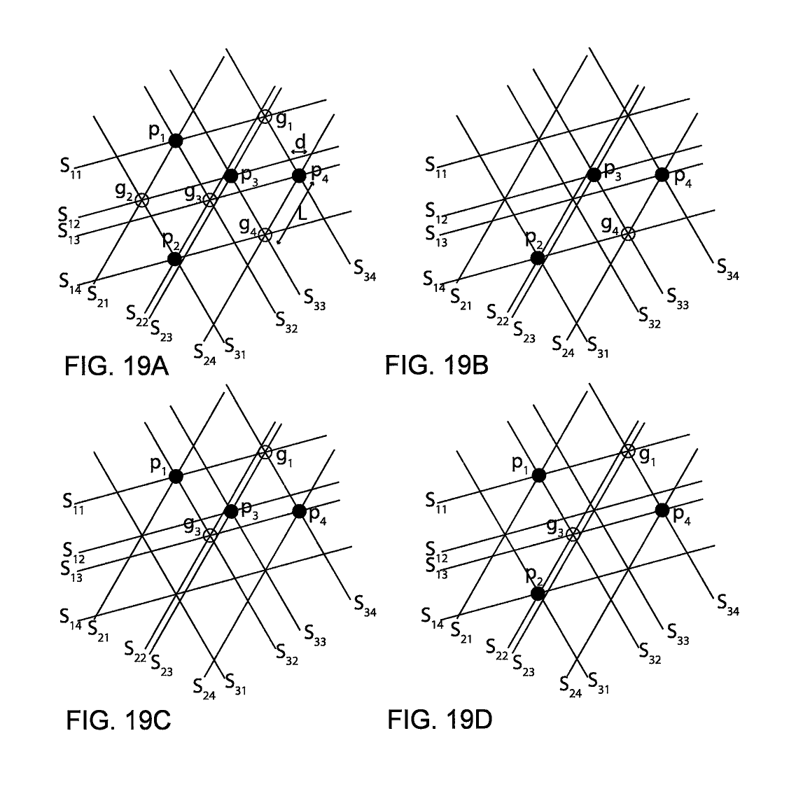

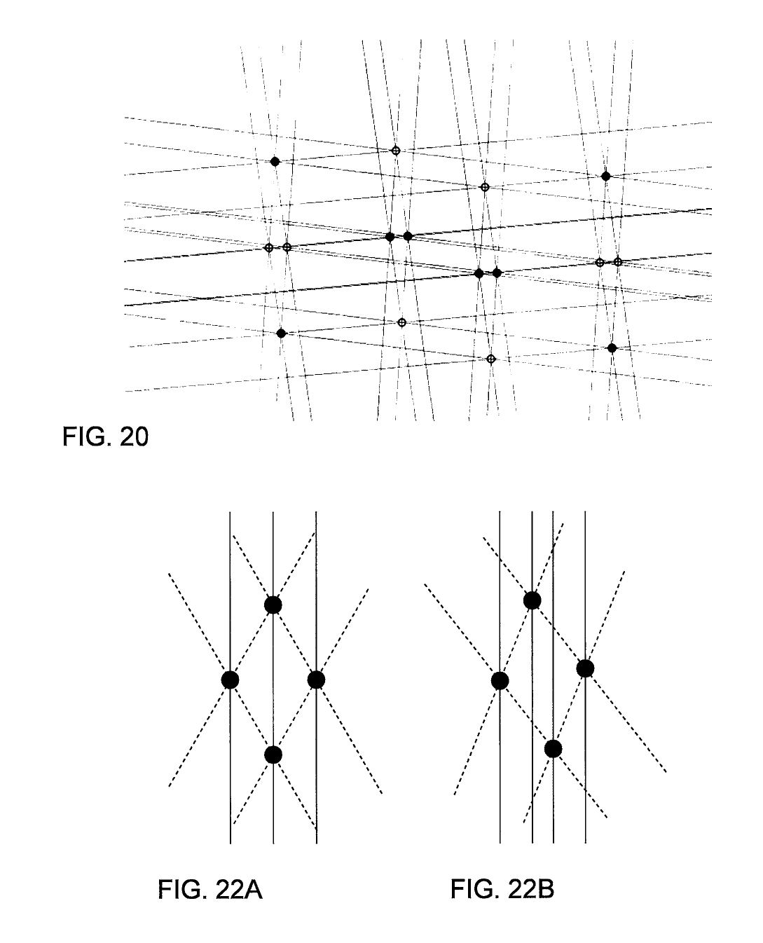

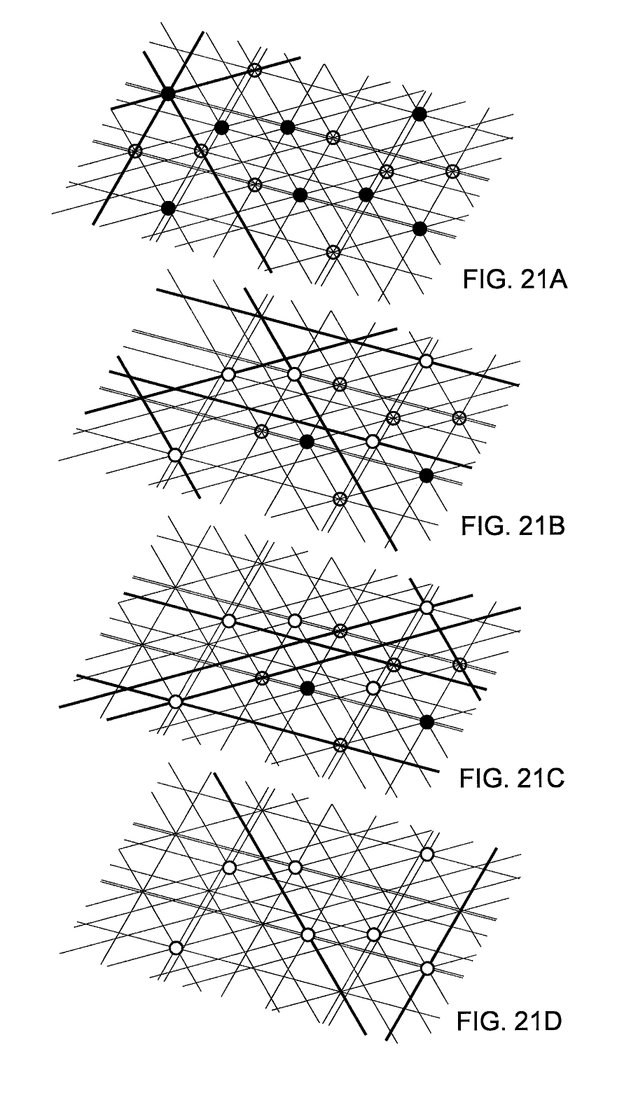

As indicated above, there are combinations of touch points that cannot be resolved, so-called degenerated cases. Thus, in a degenerated case, it is not possible to distinguish, based on the measurement signals, between two or more sets of touch points on the panel. The geometry of these degenerated cases depends on the number of sheets used and the mutual acute angle between the main directions of the sheets. The occurrence of degenerated cases will be examined in the following for five different sheet arrangements: three equiangular sheets (FIGS. 15-16), a combination of a single sheet and a 20° v-sheets configuration (FIG. 17), an asymmetric sheet arrangement (FIGS. 18-19), a dual asymmetric v-sheets configuration (FIGS. 20-21), a dual asymmetric Ψ-sheets configuration (FIG. 22).

In the Figures, d denotes the diameter of a touch point, L denotes the distance between a touch point and a ghost point along light paths of one sheet, and 1 denotes the distance between a touch point and a ghost point along light paths of another sheet.

FIGS. 15A-15B illustrate a degenerated case when using three equiangular sheets. Thus, the set of touch points p₁-p₃ in FIG. 15A yields the same measurement signals as the set of touch points p₁-p₃ in FIG. 15B. This also means that it is always possible to distinguish between two touch points placed on any of the seven candidate positions in FIG. 15.

The degenerated case in FIG. 15 can be resolved if, as shown in FIG. 16A, one of the touch points p₁-p₃ is moved by a distance 1.5d in a direction that is orthogonal to one of the light paths, or as shown in FIG. 16B, one of the touch points p₁-p₃ is moved by a distance √3d, in any direction. Furthermore, the distance between two parallel light paths needs to be at least 2.5d. When this movement of a touch point is performed, there is at least one light path that passes through only one touch point. Thereby, it is possible to determine the transmission of that touch point, whereby the other touch locations can be determined by eliminating the thus-determined transmission.

FIG. 17A illustrates a degenerated case when two sheets (represented by light paths S₂ⱼ and S₃ⱼ, respectively) define a v-sheets configuration with a mutual acute angle of 20°, and the main direction of the third sheet (represented by light paths S₁ⱼ) is perpendicular to the bisector of the v-sheets. Compared to FIG. 15, the distances 1 and L become different. As the acute angle between S₂ⱼ and S₃ⱼ is reduced, the difference between 1 and L increases. If the distances 1 and L are different, it is possible to resolve the degenerated case, as shown in FIG. 17B, by rotating the set of touch points by an angle of arcsin(d/L), where d is the diameter of the points d and L is the distance between one of the points and its furthest neighbour along the light paths.

FIGS. 18A-18B illustrate an asymmetric arrangement of three sheets, in which the mutual acute angle between the sheets is 45° (between S₁ⱼ and S₂ⱼ), 75° (between S₁ⱼ and S₃ⱼ) and 60° (between S₂ⱼ and S₃ⱼ). First, it should be noted that the asymmetric sheet arrangement does not result in a degenerated case for any set of three touch points. A degenerated case occurs when a fourth touch point is introduced, e.g. to form the set of touch points p₁-p₄ shown in FIG. 18A. It can be shown that if one of the touch points p₁-p₄ is moved a large enough distance, as exemplified in FIG. 18B, the degenerated case resolves. This also means that if any one of the points in FIG. 18A is completely removed, the case resolves.

FIGS. 19B-19D further illustrates the result of removing p₁, p₂ and p₃, respectively, from the combination of touch points in FIG. 19A. Specifically, FIG. 19A illustrates a degenerated case for the asymmetric sheet arrangement of FIG. 18. As noted above, the touch points pₙ and the ghost points gₘ form a set of candidate touch points, but it is not possible to identify the touch points pₙ from the measurement signals. However, if one touch point is removed from the set of candidate touch points, the rest of the touch points can be determined unambiguously.

If touch point p₁ is removed (FIG. 19B), light paths S₁₁ and S₂₁ have a transmission equal to one (i.e. there are no touch points along these light paths), and thus the ghost points g₁ and g₂ do not exist. Then, since touch points p₂ and p₄ are the only touch points along the light paths S₃₁ and S₃₄, respectively, the corresponding transmissions t₂ and t₄ can be determined. Thereby, the transmissions of g₄ and p₃ can be calculated according to the above algorithm.

If touch point p₂ is removed (FIG. 19C), light paths S₁₄ and S₃₁ have a transmission equal to 1, and thus the ghost points g₂ and g₄ do not exist. It may be noted that light path S₂₂ will not have a transmission equal to 1 since it partly coincides with light path S₂₃. However, since touch points p₁ and p₄ are the only points along the light paths S₂₁ and S₂₄, respectively, the corresponding transmissions t₁ and t₄ can be determined. Thereby, the transmissions of g₁, g₃ and p₃ can be calculated according to the above algorithm.

If touch point p₃ is removed (FIG. 19D), light paths S₁₂ and S₃₃ have a transmission equal to one, and thus the ghost points g₂ and g₄ do not exist. Light path S₂₃ is too close to light path S₂₂ for its transmission to be equal to 1. However, since touch points p₁, p₂ and p₄ are the only points along the light paths S₂₁, S₁₄ and S₂₄, respectively, the corresponding transmissions t₁, t₂ and t₄ can be determined. Thereby, the transmissions of g₁ and g₃ can be calculated according to the above algorithm.

FIG. 20 illustrates light paths resulting from a set of 8 touch points in a touch system operating with an asymmetric dual v-sheets arrangement, similar to the one in FIG. 10A. The touch points are marked with black dots and the ghost points are marked with open dots. It is seen that there are at least one touch point and one ghost point on each light path, and hence the set of touch points represent a degenerated case. Any combination of fewer than 8 touch points can always be resolved, as will be explained with reference to FIGS. 21A-21D.

FIG. 21A illustrates light paths resulting from another combination of 8 touch points in the same touch system as FIG. 20. If the top left touch point is removed, three light paths (thicker lines in FIG. 21A) will have a transmission equal to 1. Consequently, the three ghost points on these light paths can be identified, making it possible to determine the transmission of five touch points (white dots in FIG. 21B), since these touch points are now the only touch points along a respective light path (thicker lines in FIG. 21B). After determining and eliminating the transmissions of these touch points, using the above algorithm, another five light paths (thicker lines in FIG. 21C) will have a total trans-mission of 1, allowing the remaining five ghost points to be identified. FIG. 21D illustrates a final step in which the transmission of the last two touch points is determined using two other light paths (thicker lines). The above methodology is valid for removal of any touch point from the set of touch points in FIG. 21A.

By propagating a greater number of sheets across the panel, it will be possible to unambiguously identify a greater number of touch locations. For example, a dual Ψ-sheets arrangement will only degenerate for certain combinations of 32 touch points. Thus, in theory, it is always possible to determine the individual transmission of 31 touch points.

The provision of an asymmetric dual ψ-sheets arrangement, as shown in FIG. 10C, may give more robust algorithmic steps. FIGS. 22A-22B illustrate four touch points and resulting light paths for a single set of Ψ-sheets, in a symmetric and an asymmetric arrangement, respectively. In the symmetric sheet arrangement of FIG. 22A, the orthogonal sheet (solid lines) will result in a light path that hits two touch points. In the asymmetric sheet arrangement of FIG. 22B, the corresponding light paths (solid lines) each hit a single touch point. When the individual transmissions of the touch points are determined, e.g. using the above algorithm, any inaccuracy/noise in the determined transmission of the light paths will propagate to subsequent steps of the algorithm. It should be realized that such inaccuracy/noise may be reduced by increasing the number of light paths that hit only one touch point. Thus, an asymmetric sheet arrangement may result in a more robust and precise determination of touch locations.

It should be understood that the degenerated cases are worst-case scenarios, which occur only for specific combinations of touch locations. Thus, a touch-sensing system may very well be operable to determine a greater number of simultaneous touch locations than indicated by the degenerated cases. However, the degenerated cases may indicate the average success rate for a certain touch-sensing system.

Although the foregoing examples refer to the use of measurement signals, i.e. signals generated by the detection arrangement, the actual decoding process for determining the locations of the touching objects may alternatively operate on any type of signals derived from the measurement signal, e.g. transmission signals, which are derived by dividing the measurement signals with a background signal (see below), attenuation signals (1-transmission signal), difference signals (measurement signal-background signal), logarithms thereof, etc.

### General Implementation Details

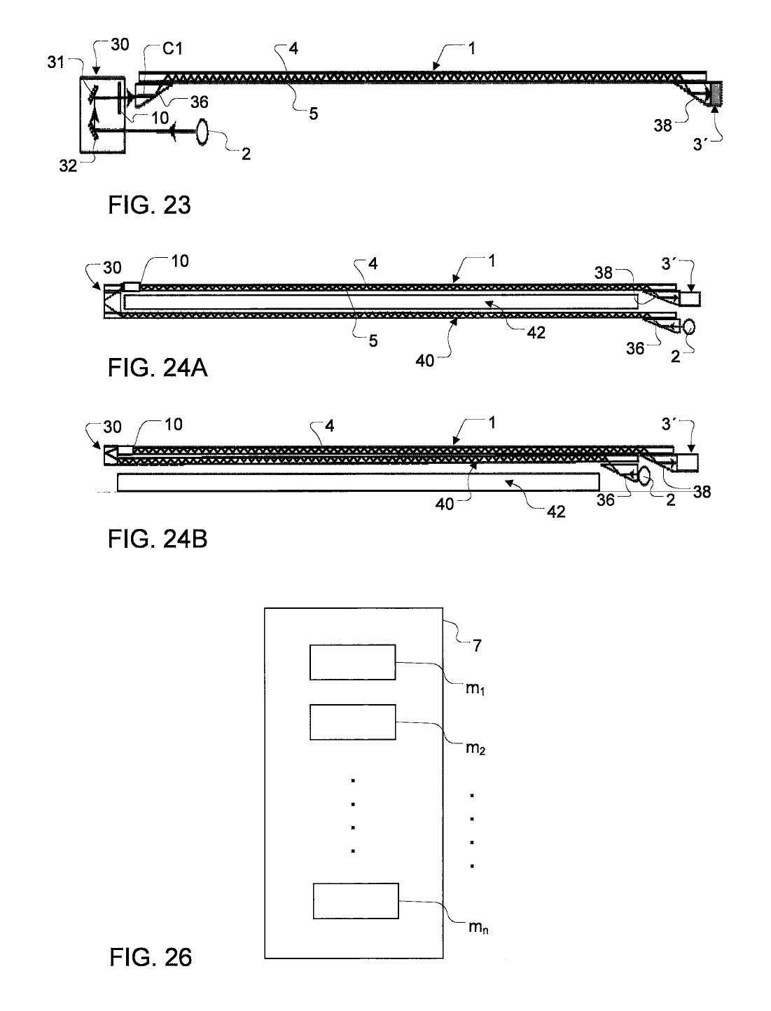

In all of the above embodiments, the panel is made of solid material, in one or more layers. The internal reflections in the touch surface are caused by total internal reflection (TIR), resulting from a difference in refractive index between the material of the panel and the surrounding medium, typically air. The reflections in the opposite boundary surface may be caused either by TIR or by a reflective coating applied to the opposite boundary surface. The total internal reflection is sustained as long as the radiation is injected into the panel at an angle to the normal of the touch surface which is larger than the critical angle at the respective injection point. The critical angle is governed by the refractive indices of the material receiving the radiation at the injection point and the surrounding material, as is well-known to the skilled person. Generally, the panel may be made of any material that transmits a sufficient amount of radiation in the relevant wavelength range to permit a sensible measurement of transmitted energy. Such material includes glass, poly(methyl methacrylate) (PMMA) and polycarbonates (PC). The panel may be of any shape, such as circular, elliptical or polygonal, including rectangular. The panel is defined by a circumferential edge surface, which may or may not be perpendicular to the top and bottom surfaces of the panel. The radiation may be coupled into and out of the panel directly via the edge portion. Alternatively, a separate coupling element may be attached to the edge portion or to the top or bottom surface of the panel to lead the radiation into or out of the panel. Such a coupling element may have the shape of a wedge (cf. FIGS. 23-24 described below).

The touch-sensing system may also include an interface device that provides a graphical user interface (GUI) within at least part of the sensing area. The interface device may be in the form of a substrate with a fixed image that is arranged over, under or within the panel. Alternatively, the interface device may be a screen (e.g. an LCD—Liquid Crystal Display, a plasma display, or an OLED display—Organic Light-Emitting Diode) arranged underneath or inside the system, or a projector arranged underneath or above the system to project an image onto the panel. Such an interface device may provide a dynamic GUI, similar to the GUI provided by a computer screen.

Although not shown in the drawings, an anti-glare (AG) structure may be provided on one or both of the top and bottom surfaces of the panel. The AG structure is a diffusing surface structure which may be used to reduce glares from external lighting on the surface of the panel. Such glares might otherwise impair the ability of an external observer to view any information provided on the panel by the aforesaid interface device. Furthermore, when the touching object is a naked finger, the contact between the finger and the panel normally leaves a fingerprint on the surface. On a perfectly flat surface, such fingerprints are clearly visible and usually unwanted. By adding an AG structure to the surface, the visibility of fingerprints is reduced. Furthermore, the friction between finger and panel decreases when an anti-glare is used, thereby improving the user experience. Anti-glares are specified in gloss units (GU), where lower GU values result in less glares. In one embodiment, the touch surface(s) of the panel has a GU value of 10-200, preferably 100-120.

In the above-described embodiments, emitters 2 and/or light sensors 3 or output scanners 14 are placed outside the perimeter of the panel 1. This might be undesirable, e.g. if the touch-sensing system is to be integrated with an interface device, e.g. a display device. If components of the touch-sensing system are arranged far from the perimeter of the display, the surface area of the complete system may become undesirably large.

FIG. 23 is an elevated side view of a touch-sensing system which is provided with an illumination arrangement as shown in FIG. 2A and a detection arrangement as shown in FIG. 5. One beam path is folded, by a folding system 30, to allow the emitter 2 to be placed underneath the panel 1. In the system of FIG. 23, a fan beam (only center ray is shown) is emitted from the emitter 2 towards the folding system 30. After entering the folding system 30, the beam is first reflected in stationary mirror 32 and thereafter in stationary mirror 34, whereby the beam is folded onto an elongate coupling element 36. The folded beam then passes through the collimating device (lens) 10 and enters the panel 1 via the coupling element 36, which defines an elongate incoupling site and which may be attached to the panel 1. The collimated sheet C1 propagates through the panel 1 by internal reflection and exits the panel 1 at an elongate outcoupling site, via an elongate outcoupling element 38, and is received by the array 3′.

In all embodiments, the touch-sensing system may include a transportation device, which is arranged underneath the panel to define a confined light guiding channel in the illumination arrangement between the emitter and the injection site on the panel, and/or in the detection arrangement between the outcoupling site on the panel and the output scanner/array. The use of such a transportation device makes it possible to gather the bulk of components at one or a few sides of the panel.

FIGS. 24A-24B illustrate variants of the embodiment in FIG. 23, wherein a transportation device 40 is incorporated in the form of a transportation plate, which may be made of the same material as the panel 1 or any other sufficiently light-transmissive material or combination of materials. The transportation plate 40 suitably has an extent to allow for the above-mentioned fan beam(s) to diverge within the plate 40 and may have essentially the same size as the panel 1. In FIG. 24A, the transportation plate 40 is spaced from the panel 1, to accommodate for an interface device 42 to be placed between the panel 1 and the plate 40. In FIG. 24B, the plate 40 is placed in contact with the panel 1, or may be formed as an integrated layer in the panel 1. In both examples, the touch-sensing system includes a distal folding system 30 that directs the fan beam(s) from the transportation plate 40 into the panel 1. In the example of FIG. 24, the collimating device 10 is included in the distal folding system 30. This will minimize the distance between the collimating device 10 and the array 3′, and thereby reduce the impact of inaccuracies in the collimating device 10 and/or reduce the footprint of the system.

Generally, the use of a transportation plate 40 may provide a touch-sensing system that is simple, compact, robust and easy to assemble. The beams may be confined within the plate by total internal reflection, and/or by the plate 40 being coated with one or more reflecting layers (not shown). In alternative embodiments (not shown), the touch-sensing system may comprise more than one transportation device. For example, the individual beams may be guided in separate transportation devices, or the system may include one or more transportation devices for guiding the beams to the panel and one or more transportation devices for guiding the beams from the panel. Other types of transportation devices may alternatively be used, such as optical fibers.

### Determination of Touch Locations

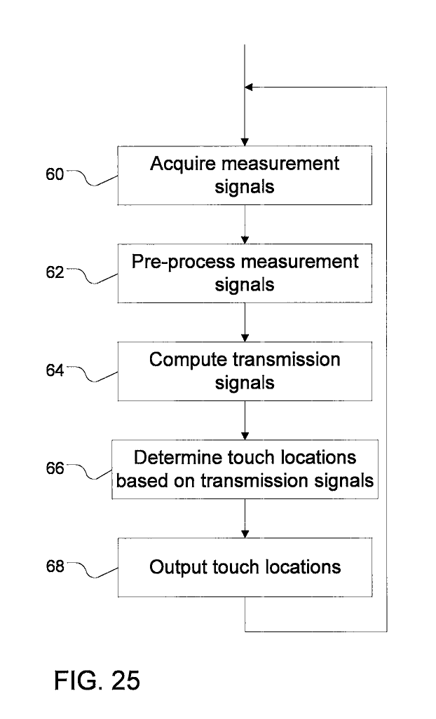

In all of the above-described embodiments, configurations, arrangements, alternatives and variants, a data processor (7 in FIG. 1A) may be configured to calculate the touch locations based on measurement signals derived from the detection arrangement. The skilled person will readily realize that there are numerous methods for determining the touch locations. FIG. 25 is a flow chart of one such exemplifying method.

In step 60, measurement signals (cf. signals Sⱼ in FIGS. 13-14) are acquired from the detection arrangement. From an output scanner (14 in FIG. 4), the measurement signal is typically a series of energy values, sampled at N time intervals during a sensing instance. From an light-sensing array (3′ in FIG. 5), the measurement signal is typically a set of energy values sampled from N different light-sensing elements during a sensing instance. In either variant, each energy value is indicative of light energy at a known spatial position within the relevant outcoupling site.

In step 62, the measurement signals are pre-processed. For example, the measurement signals may be processed for noise reduction using standard filtering techniques, e.g. low-pass filtering, median filters, Fourier-plane filters, etc. Furthermore, if the energy of the emitters is measured in the system, the measurement signals may be compensated for temporal energy fluctuations in the emitted beams. Furthermore, the measurement signals may contain sensor readings from outside the region of interest, e.g. outside the sensing area of the panel. Thus, the measurement signals may be pre-processed by extracting relevant parts thereof.

Furthermore, step 62 may also involve mapping the sequence of energy values acquired from an output scanner (14 in FIG. 4) to a sequence of spatial positions in the panel coordinate system. This may e.g. be done by identifying, in the measurement signal, a trigger point that corresponds to a known spatial position. Such a trigger point may e.g. indicate the start or stop of a sweep of the output scanner. Based on an actual or predetermined sweep function of the output scanner, or its average sweep speed, time points in the measurement signal can be associated with spatial positions in the panel coordinate system. If necessary or desired, the measurement signals may also be rectified, i.e. converted to have equidistant sampling distance in the panel coordinate system. Such a rectification may include interpolating each measurement signal with a non-linear angle variable, resulting in a data set with samples that are evenly distributed in the panel coordinate system. Rectification is optional, but may simplify the subsequent computation of touch locations.

In step 64, a transmission signal is calculated for each pre-processed measurement signal, by dividing the measurement signal with a background signal. The background signal represents the transmitted energy with no objects touching the panel, and thus indicates the spatial distribution of radiation at the outcoupling site. The background signal may or may not be unique to each measurement signal. The background signal may be pre-set, derived during a separate calibration step (without any objects touching the panel), or derived from measurement signals acquired during one or more preceding iterations, possibly by averaging a set of such measurement signals. Optionally, the calculation of transmission signals may include calculating the logarithm of the ratios between the measurement and background signals.

In step 66, the touch locations are determined based on the transmission signals. The touch-sensing systems as described herein may be modeled using known algorithms developed for transmission tomography with a parallel scanning geometry or a fan beam geometry. In essence, the touch locations may be reconstructed using any available image reconstruction algorithm, especially few-view algorithms that are used in, e.g., the field of tomography. Another technique for reconstructing the distribution of energy/transmission/attenuation across the touch surface is disclosed in Applicant's U.S. provisional application No. 61/272,667, which was filed on Oct. 19, 2009 and which is incorporated herein by this reference.

The determination of touch locations in step 66 may thus involve identifying peaks in the transmission signals, while possibly also separating adjacent/overlapping peaks; reconstructing the light rays that correspond to the identified peaks, and identifying candidate intersections between the reconstructed beams in the sensing area; computing an area value indicative of the (logarithmic) integrated area under each identified peak in the transmission signals, and setting up an equation system relating the candidate intersections to the area values; and then using e.g. linear programming to identify the most likely set of touches from the set of candidates. The accuracy and/or computation speed of step 66 may be increased by using a priori knowledge about the touch locations, e.g. by using information about the touch locations that were identified during preceding sensing instance(s).

To give a simplified example, based on the measurement/transmission signals in FIG. 13A, the peaks in signal S1 may yield logarithmic areas a11, a12, and the peaks in signal S2 may yield logarithmic areas a21, a22, a23. Beam reconstruction may yield six intersections p1, p2, p3, g1, g2, g3 giving the equation system:

$$\{ \begin{matrix}p 1 + g 1 + p 2 = a 11 \\ g 3 + p 2 + p 3 = a 12 \\ p 1 + g 3 = a 21 \\ g 1 + p 2 = a 22 \\ g 2 + p 3 = a 23\end{matrix}$$

This particular example, with multiple touches and comparatively few sheets, results in an equation system that has a number of possible solutions, or no solution, requiring the use of optimization methodology to derive the most likely set of touches.

After step 66, the determined touch locations are output and the method returns to step 60 for processing of a forthcoming sensing instance.

### Data Processor

The above-mentioned data processor 7 is further exemplified in FIG. 26. As shown the data processor 7 comprises a set of elements or means m₁-mₙ for executing different processing steps in the above-described decoding process. The data processor may be implemented by special-purpose software (or firmware) run on one or more general-purpose or special-purpose computing devices. In this context, it is to be understood that each “element” or “means” of such a computing device refers to a conceptual equivalent of a method step; there is not always a one-to-one correspondence between elements/means and particular pieces of hardware or software routines. One piece of hardware sometimes comprises different means/elements. For example, a processing unit serves as one element/means when executing one instruction, but serves as another element/means when executing another instruction. In addition, one element/means may be implemented by one instruction in some cases, but by a plurality of instructions in some other cases. Such a software controlled computing device may include one or more processing units, e.g. a CPU (“Central Processing Unit”), a DSP (“Digital Signal Processor”), an ASIC (“Application-Specific Integrated Circuit”), discrete analog and/or digital components, or some other programmable logical device, such as an FPGA (“Field Programmable Gate Array”). The computing device may further include a system memory and a system bus that couples various system components including the system memory to the processing unit. The system bus may be any of several types of bus structures including a memory bus or memory controller, a peripheral bus, and a local bus using any of a variety of bus architectures. The system memory may include computer storage media in the form of volatile and/or non-volatile memory such as read only memory (ROM), random access memory (RAM) and flash memory. The special-purpose software may be stored in the system memory, or on other removable/non-removable volatile/non-volatile computer storage media which is included in or accessible to the computing device, such as magnetic media, optical media, flash memory cards, digital tape, solid state RAM, solid state ROM, etc. The computing device may include one or more communication interfaces, such as a serial interface, a parallel interface, a USB interface, a wireless interface, a network adapter, etc, as well as one or more data acquisition devices, such as an A/D converter. One or more I/O devices may be connected to the computing device, via a communication interface, including e.g. a keyboard, a mouse, a touch screen, a display, a printer, a disk drive, etc. The special-purpose software may be provided to the computing device on any suitable computer-readable medium, including a record medium, a read-only memory, or an electrical carrier signal.

The invention has mainly been described above with reference to a few embodiments. However, as is readily appreciated by a person skilled in the art, other embodiments than the ones disclosed above are equally possible within the scope and spirit of the invention, which is defined and limited only by the appended patent claims.

For example, one or more of the optical components described in the foregoing may be combined into a single optical unit, or the functionality of a single optical component described in the foregoing may be provided by a combination of components. For example, it is conceivable to integrate the collimating device or the focusing device into the coupling element for coupling radiation into/out of the panel.

1. An apparatus for determining a location of at least one object on a touch surface, said apparatus comprising:
a panel defining the touch surface and an opposite surface;
an illumination arrangement configured to generate a first set of sheets of light and to introduce the first set of sheets via a first elongate incoupling site on the panel such that the first set of sheets propagate by internal reflection between the touch surface and the opposite surface, whereby at least two sheets in the first set of sheets overlap in a portion of the touch surface such that the object interacts with said at least two sheets;
a detection arrangement configured to couple the first set of sheets out of the panel at a first elongate outcoupling site on the panel and generate output signals indicative of the energy of each sheet at a set of spatial points within the first outcoupling site; and
a data processor connected to the detector arrangement for determining the location of the object based on the output signals.

2. An apparatus of claim 1, wherein each sheet in the first set is essentially collimated in the plane of the panel along a different main direction.

3. The apparatus of claim 2, wherein the main directions of the first set of sheets define a maximum mutual acute angle of ≦30°, and preferably ≦20°.

4. The apparatus of claim 2, wherein two of the main directions in the first set are angled on either side of a direction parallel to a linear edge portion of the panel.

5. The apparatus of claim 4, wherein another main direction in the first set of sheets is essentially parallel to said linear edge portion of the panel.

6. The apparatus of claim 2, wherein each pair of main directions in the first set has a mutual acute angle that is unique within the first set.

7. The apparatus of claim 1, wherein the illumination arrangement is configured to generate a second set of sheets of light and to introduce the second set of sheets via a second elongate injection site on the panel such that the second set of sheets propagate by internal reflection between the touch surface and the opposite surface, wherein each sheet in the second set is essentially collimated in the plane of the panel along a different main direction; and wherein the detection arrangement is configured to couple the second set of sheets out of the panel at a second elongate outcoupling site on the panel and generate output signals indicative of the energy of each sheet at a set of spatial points within the outcoupling site.

8. The apparatus of claim 7, wherein the first incoupling site is located at a first edge portion of the panel, and the first outcoupling site is located at a second edge portion opposite to the first edge portion, and wherein second incoupling site is located at a third edge portion of the panel, and the second outcoupling site is located at a fourth edge portion opposite to the third edge portion.

9. The apparatus of claim 8, wherein the first and second incoupling sites are parallel to the first and third edge portion, respectively.

10. The apparatus of claim 7, wherein the first and second incoupling sites are mutually orthogonal.

11. (canceled)

12. The apparatus of claim 7, wherein the first set comprises three sheets of light and/or the second set comprises three sheets of light.

13-14. (canceled)

15. The apparatus of claim 1, wherein the illumination arrangement comprises a first elongate collimating device that defines an input focal plane, wherein the collimating device is arranged to receive at least two input beams of light that diverge from a respective point of origin in said input focal plane, thereby causing the collimating device to output said first set of sheets.

16. The apparatus of claim 1, wherein the illumination arrangement comprises an elongate grating structure which is arranged to split an incoming beam of light into a set of diffracted beams that form said first set of sheets.

17. The apparatus of claim 16, wherein said incoming beam of light is essentially collimated so as to have an essentially constant angle of incidence along the elongate grating structure.

18. The apparatus of claim 17, wherein the illumination arrangement further comprises an elongate collimating device which is arranged to generate said incoming beam of light for the grating structure, wherein the collimating device defines an input focal plane and is arranged to receive an input beam of light that diverges from a point of origin in said focal plane.

19. The apparatus of claim 15, wherein the illumination arrangement comprises a plate-shaped radiation guide which is arranged underneath the panel, as seen from the touch surface, and a beam-folding system which is arranged to optically connect the radiation guide to the panel, wherein the radiation guide is configured to guide said input beam(s) by internal reflection from one or more emitters to the beam-folding system.

20. The apparatus of claim 1, wherein the detection arrangement comprises an array of radiation-sensing elements, which is arranged to optically face the outcoupling site such that different radiation-sensing elements receive light from different spatial points.

21. (canceled)

22. The apparatus of claim 1, wherein the detection arrangement is arranged to measure the energy for each sheet at the spatial points in the first outcoupling site as a function of time.

23-26. (canceled)

27. A method of operating an apparatus for determining a location of at least one object on a touch surface, said touch surface being part of a panel that defines the touch surface and an opposite surface, said method comprising the steps of:
operating an illumination arrangement to generate a first set of sheets of light and to introduce the first set of sheets via a first elongate incoupling site on the panel such that the first set of sheets propagate by internal reflection between the touch surface and the opposite surface to a first elongate outcoupling site, whereby at least two sheets in the first set of sheets overlap in a portion of the touch surface such that the object interacts with said at least two sheets;
operating a detection arrangement to generate output signals indicative of the energy of each sheet at a set of spatial points within the first outcoupling site; and
determining the location of the object based on the output signals.

28. A computer program product comprising computer code which, when executed on a data-processing system, is adapted to carry out the method of claim 25.
